(19) United States
(12) Patent Application Publication
(10) Pub. No.: US 2003/0012249 A1
(43) Pub. Date: Jan. 16, 2003

(54) Monolithic piezoelectrically-tunable optoelectronic device structures and methods for fabricating same

(75) Inventor: Kurt W. Eisenbeiser, Tempe, AZ (US)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: Motorola, Inc., Schaumburg, IL

(21) Appl. No.: 09/903,740

(22) Filed: Jul. 13, 2001

(51) Int. Cl. H01S 3/08

(52) U.S. Cl. 372/96

(57) ABSTRACT

The present invention provides a monolithic piezoelectrically-tunable optoelectronic device structure which includes an epitaxial piezoelectric material that is monolithically integrated with an optical device, such as a laser structure or a photodetector structure for example. In alternate embodiments, the epitaxial piezoelectric material may be monolithically integrated either above or below the active layer of the optical device or may be positioned adjacent to the optical device. A vertical cavity surface emitting laser diode which monolithically integrates a piezoelectric thin-film exhibits high tunability and improved performance.

### FIELD OF THE INVENTION

This invention relates generally to optical semiconductor devices and, more particularly, to integrated piezoelectrically-tunable optical device structures and methods for fabricating such structures.

### BACKGROUND OF THE INVENTION

Wavelength-tunable optical devices, such as laser diodes and photodetectors, are useful in a variety of applications, including telecommunications, medicine, material diagnostics, spectroscopy, isotope separation, and remote sensing. In particular, tunable lasers and photodetectors are important components in dense wavelength division multiplexed (DWDM) optical communications systems. DWDM is a fiber-optic transmission process which combines, simultaneously transmits, and then receives multiple optical carrier signals of distinct wavelengths through separate, parallel channels on a single optical fiber. Such systems and processes enable the transmission of large volumes of data at comparatively high speeds. Broadband laser diodes and photodetectors that can be tuned to provide or receive, respectively, output carrier signals over the spectrum spanned by the various channels of these DWDM systems offer the potential for substantially increasing the transmission capacity of multi-wavelength optical networks and are, therefore, in great demand.

Vertical cavity surface emitting lasers (VCSELs) have become the subject of increasing interest for use in a variety of laser applications, including optical communications systems, such as DWDM systems. This is due, at least in part, to the advantages provided by the optical beam geometry of these lasers. Surface emitting lasers comprise large emitter areas coupled with a low divergence angle and, accordingly, improved light beam quality. These characteristics are easily adapted to produce monolithic two-dimensional laser arrays whose light output can travel efficiently along optical fibers. Since the volume of information that may be transmitted through an optical fiber is directly proportional to the number of distinct carrier signals or wavelengths capable of simultaneous transmission along that optical fiber, a VCSEL which permits multiple output wavelengths from a single lasing source would facilitate the transmission of large amounts of data at reduced cost and would therefore be highly desirable. One means of achieving multiple output wavelengths from a single VCSEL is by selectively inducing changes in the bandgap of the lasing material such that a broad emission spectrum may be produced. As laser structures typically comprise crystalline lasing materials, crystal lattice strain may be employed to manipulate the bandgap of the lasing material and therefore tune the output wavelength of the VCSEL.

Piezoelectrically-induced mechanical stress has been demonstrated as a viable method of tuning the wavelength of optoelectronic devices. See, “Piezoelectrically Induced Stress Tuning of Electro-Optic Devices”, Appl. Phys. Lett. 59 (27), p. 359 (Dec. 30, 1991), incorporated herein by reference. As schematically illustrated in cross-section in FIG. 1, a laser structure 10 may be fabricated by placing a piezoelectric thin-film 12, such as BaTiO₃, ZnO, or Pb(Zr,Ti)O₃, directly on a semiconductor substrate 11 and adjacent to an active lasing layer 14 of a double-heterostructure laser; adding metal control electrodes 16 above the piezoelectric thin-film 12; and then connecting the electrodes 16 together. When a bias is applied between N-doped reflective layers 18 and P-doped reflective layers 20 on either side of the active layer 14, and a voltage V_{c} is applied between the semiconductor substrate 11 and the control electrodes 16, the electric field thus created in the piezoelectric thin-film 12 converts the electric control signal into a mechanical stress on the crystal structure of the material of the active layer 14. This mechanical stress, which is transferred by the piezoelectric thin-film 12 across the active layer 14, changes the bandgap energy and, therefore, the output wavelength of the active layer 14.

A piezoelectrically-tuned laser diode fabricated in this manner is disadvantageous in several regards. First, a piezoelectric oxide material, such as any of the materials mentioned above with reference to thin-film 12 of FIG. 1, which is formed directly on a semiconductor substrate will not be monocrystalline. Accordingly, the piezoelectric coefficient of this thin-film necessarily will be less than the piezoelectric coefficient of a monocrystalline thin-film and, therefore, will reduce the tuning range of the associated laser structure. Second, mechanical placement of a monocrystalline piezoelectric material on the semiconductor substrate to form the structure depicted in FIG. 1, rather than monolithic growth of the piezoelectric thin-film directly on the substrate, results in reduced coupling efficiency of the laser structure as well as increased fabrication costs.

Accordingly, there is a need for a monolithic piezoelectrically-tunable optical device structure which provides reduced fabrication costs, high-tunability, and improved performance. There is also a need for a method of fabricating a monolithic piezoelectrically-tunable optical device structure which epitaxially integrates a monocrystalline piezoelectric thin-film with both a laser structure and silicon control circuitry to thereby provide cost-effective, highly-tunable laser diodes and photodetectors. There is also a need for a vertical cavity surface emitting laser diode which monolithically integrates a monocrystalline piezoelectric thin-film and exhibits high tunability and improved performance. Additionally, there is a need for a photodetector which monolithically integrates a monocrystalline piezoelectric thin-film and exhibits high tunability and improved performance.

### BRIEF DESCRIPTION OF THE DRAWINGS

The present invention is illustrated by way of example, and not of limitation, in the accompanying figures, in which like references indicate similar elements, and in which:

FIG. 1 illustrates a prior art piezoelectrically-tunable device structure;

FIGS. 2A and 2B schematically illustrate cross-sectional views of a piezoelectrically-tunable device structure in accordance with alternate embodiments of the invention;

FIG. 3 graphically illustrates maximum attainable film thickness for a high-quality grown crystal layer as a function of the degree of lattice mismatch between a host crystalline material and the grown crystalline material;

FIGS. 4A and 4B schematically illustrate cross-sectional views of a piezoelectrically-tunable laser structure in accordance with further embodiments of the invention;

FIGS. 5A and 5B schematically illustrate cross-sectional views of a piezoelectrically-tunable laser structure in accordance with still further embodiments of the invention;

FIGS. 6A and 6B schematically illustrate cross-sectional views of a piezoelectrically-tunable photodetector structure in accordance with further embodiments of the invention;

FIGS. 7A and 7B schematically illustrate cross-sectional views of a piezoelectrically-tunable photodetector structure in accordance with still further embodiments of the invention;

FIGS. 8A-8C schematically illustrate cross-sectional views of a piezoelectrically-tunable device structure in accordance with still further embodiments of the invention;

FIG. 9 schematically illustrates a cross-sectional view of a portion of an optical device on a semiconductor substrate in accordance with an embodiment of the present invention.

Skilled artisans will appreciate that the elements in the figures are illustrated for simplicity and clarity and have not necessarily been drawn to scale. For example, the dimensions of some of the elements in the figures may be exaggerated relative to other elements to enhance understanding of the various embodiments of the present invention.

### DETAILED DESCRIPTION OF THE INVENTION

The following disclosure presents and describes various exemplary embodiments in sufficient detail to enable those skilled in the art to practice the invention, and it should be understood that other embodiments may be realized without departing from the spirit and the scope of the invention. Thus, the following detailed description is presented for purposes of illustration only, and not of limitation, and the scope of the invention is defined solely by the appended claims.

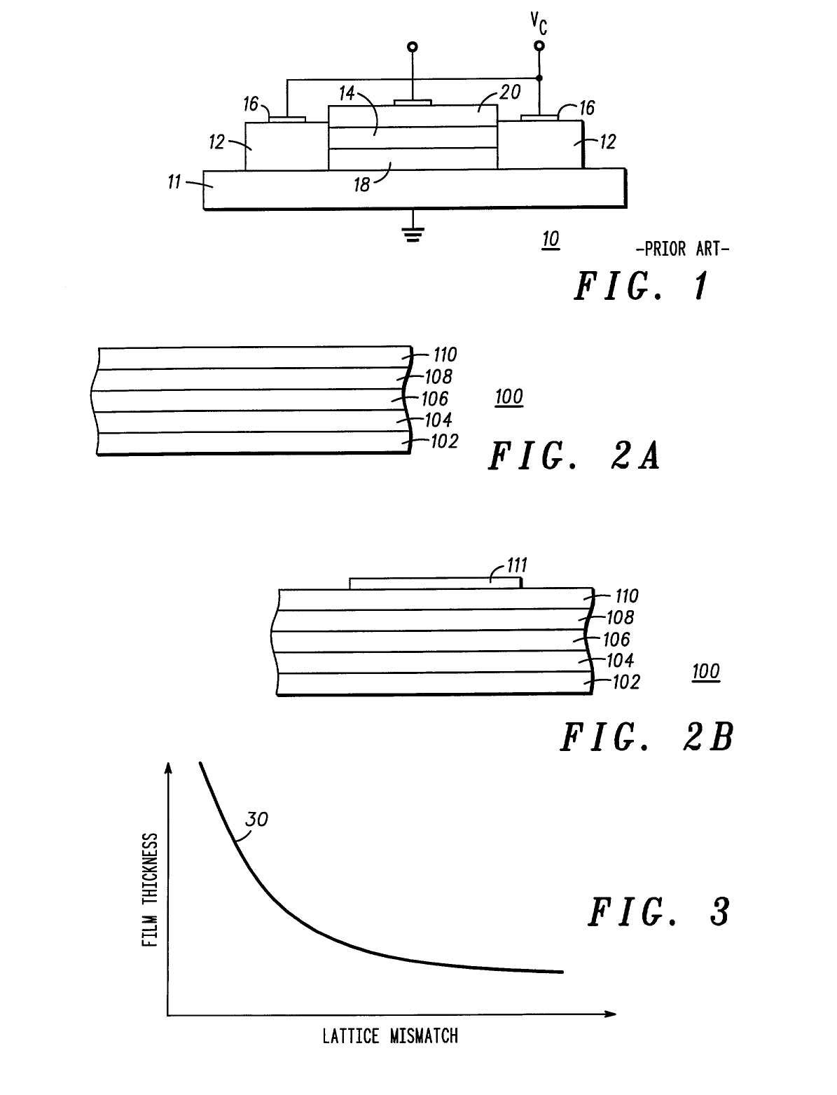

A cross-sectional view of an exemplary embodiment of a portion of a tunable optoelectronic device structure in accordance with the present invention is shown in FIG. 2A. Tunable device structure 100 includes a monocrystalline substrate 102, a monocrystalline accommodating buffer layer 104 positioned over substrate 102, a monocrystalline piezoelectric material layer 106 positioned over buffer layer 104, a monocrystalline template layer 108 positioned over piezoelectric material layer 106, and an optical device 110 positioned over the template layer 108. As described below, optical device 110 may comprise either a laser structure or a photodetector structure. Further, as presented in greater detail below, an alternate embodiment of structure 100 may also include an amorphous intermediate layer 112 positioned between substrate 102 and buffer layer 104. As used herein, the term “monocrystalline” shall have the meaning commonly used within the semiconductor industry. The term shall refer to materials that are a single crystal or that are substantially a single crystal and shall include those materials having a relatively small number of defects such as dislocations and the like as are commonly found in substrates of silicon or germanium or mixtures of silicon and germanium and epitaxial layers of such materials commonly found in the semiconductor industry.

Substrate 102, in accordance with an embodiment of the invention, is a monocrystalline semiconductor or compound semiconductor material. Substrate 102 can comprise, for example, a material from Group IV of the periodic table or a compound material from Groups III and V. Examples of suitable substrate materials include silicon, germanium, mixed silicon and germanium, mixed silicon and carbon, mixed silicon, germanium and carbon, gallium arsenide, indium phosphide, and the like. Preferably, substrate 102 is a wafer comprising silicon or germanium and, most preferably, is a high-quality monocrystalline silicon wafer, as used in the semiconductor industry.

In one embodiment, substrate 102 comprises a <100> or <111> oriented monocrystalline silicon wafer. In another embodiment, substrate 102 may comprise a <001> Group IV material that has been off-cut towards a <110> direction. The growth of material layers on a miscut Si <001> substrate is known in the art. For example, U.S. Pat. No. 6,039,803, issued to Fitzgerald et. al on Mar. 21, 2000, which patent is herein incorporated by reference, is directed to the growth of silicon-germanium and germanium layers on miscut Si <001> substrates. Substrate 102 may be off-cut in the range of from about 2° to about 6° towards the <110> direction. A miscut Group IV substrate reduces dislocations and results in the improved quality of subsequently grown layers.

Monocrystalline accommodating buffer layer 104 is preferably a monocrystalline oxide or nitride material selected for its crystalline compatibility with both the underlying substrate and the overlying material layer. For example, the material could be an oxide or nitride having a lattice structure closely matched to the lattice structures of both the substrate 102 and the subsequently applied piezoelectric material layer 106. Materials that are suitable for the buffer layer 104 include metal oxides, such as the alkaline-earth metal titanates, alkaline-earth metal zirconates, alkaline-earth metal hafnates, alkaline-earth metal tantalates, alkaline-earth metal ruthenates, alkaline-earth metal niobates, and alkaline-earth metal vanadates; perovskite oxides, such as alkaline-earth metal tin-based perovskites; and lanthanide series oxides, such as lanthanum aluminate, lanthanum scandium oxide, and gadolinium oxide. Additionally, various nitrides, such as gallium nitride, aluminum nitride, and boron nitride, may also be used for the buffer layer 104. Most of these materials are insulators, though others may be conductors, such as strontium ruthenate for example. Generally, these materials are metal oxides or metal nitrides, and, more particularly, these metal oxides or metal nitrides typically include at least two different metallic elements. In particular applications, the metal oxides or metal nitrides may include three or more different metallic elements. Buffer layer 104 may have a thickness of about 20-1000 Å and preferably has a thickness of about 50-100 Å.

In an exemplary embodiment, substrate 102 is a monocrystalline substrate such as a monocrystalline silicon or gallium arsenide substrate. The crystalline structure of the monocrystalline substrate is characterized by both a lattice constant and a crystal orientation. In a similar manner, buffer layer 104 also comprises a monocrystalline material, and the crystal structure of this monocrystalline material is characterized by both a lattice constant and a crystal orientation. As used herein, the phrase “lattice constant” refers to the distance between atom centers for two atoms located on one side of the cube which embodies the unit cell of the crystalline material. The lattice constants of the buffer layer 104 and the substrate 102 preferably are closely matched or, alternatively, are such that rotation of the orientation of one crystal with respect to the orientation of the other crystal achieves a substantial match in lattice constants. In this context, the terms “substantially equal” and “substantially matched” mean that there is sufficient similarity between the lattice constants to permit the growth of a high-quality crystalline layer over the underlying host crystal layer.

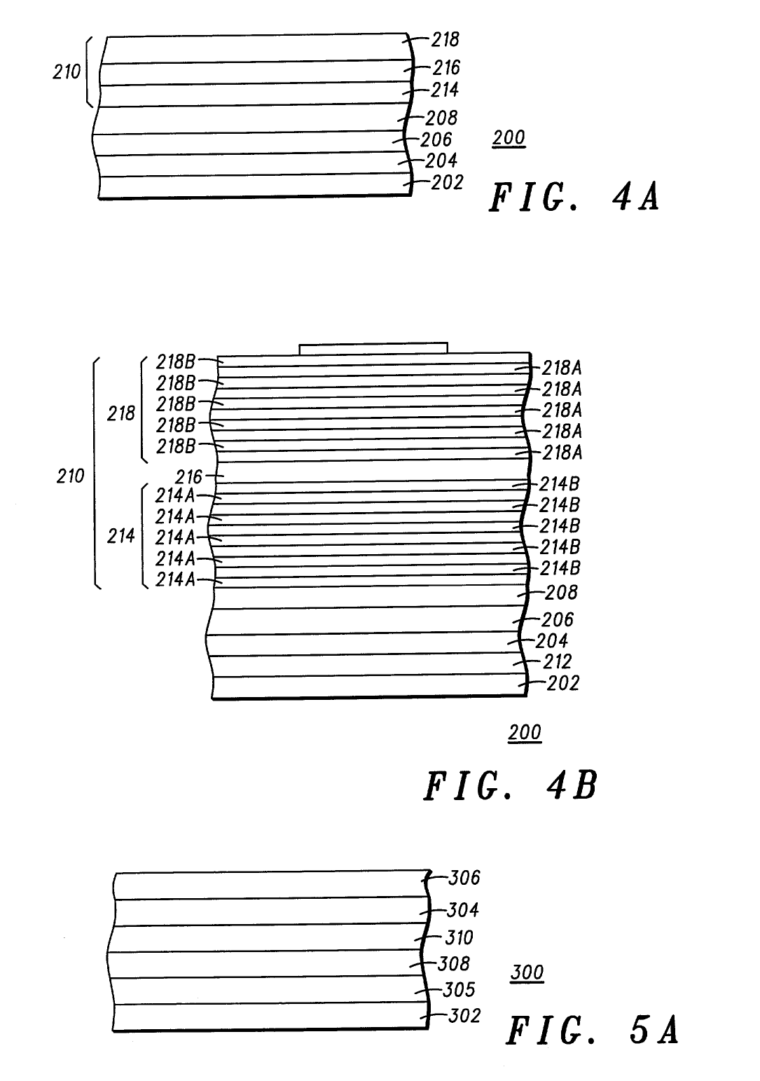

FIG. 3 graphically illustrates the maximum achievable thickness of a grown crystal layer having a high crystalline quality as a function of the degree of mismatch between the lattice constants of a host crystal and the grown crystal. Curve 30 illustrates the boundary of high crystalline quality material. The area to the right of curve 30 represents layers that have a large number of defects. With no lattice mismatch, it is theoretically possible to grow an infinitely thick, high-quality epitaxial layer on a host crystal. As the mismatch in lattice constants between the host crystalline material and the grown crystalline material increases, the maximum attainable thickness of a grown crystalline layer having high crystalline quality decreases rapidly. As a reference point, for example, if the lattice constants between the host crystal and the grown layer are mismatched by more than about 2%, monocrystalline epitaxial layers in excess of about 20 nm cannot be achieved.

The optical properties of an optical device, such as a laser structure or a photodetector structure, can be tuned or manipulated by introducing mechanical stress or strain into the crystal structure of the materials forming the optical device. One method of inducing lattice strain in a material structure is to place the structure in intimate contact with a piezoelectric material whose lattice constant may be altered through an applied electrical bias. Alteration of the lattice constant of a piezoelectric material that is intimately coupled to an optical device transfers mechanical stress to the crystal structure of the material layers comprised by the optical device. This induced strain modifies the band structure of the material layers and, more specifically, the bandgap of the active layer of the optical device. In the case of a laser structure, since the bandgap of a lasing material layer is inversely proportional to the output wavelength or carrier signal of that lasing material layer, altering the bandgap effectively modifies the carrier signal. Of course, the more direct the means for coupling the piezoelectric material with the active lasing material, the more sensitive the laser structure is to tuning. Until now, monolithic integration of a piezoelectric oxide material with the lasing material of a laser structure has not been successfully accomplished. However, monolithic integration of these two types of materials within a single structure affords a cost effective, highly tunable laser structure which exhibits improved performance over the prior art in a variety of optical communications applications.

Additionally, in the case of a photodetector structure, the bandgap of the active layer of the photodetector structure is inversely proportional to the longest wavelength of the light absorbed by the photodetector. Since the bandgap of the active layer sets the upper limit for the wavelengths of light to which the detector can respond, a photodetector will generate an electrical current in response to the absorption of light which has a wavelength that is either equal to or less than the wavelength which corresponds to the bandgap of the active layer. If the bandgap of the active layer can be altered, then the wavelength(s) of light to which the photodetector can respond also can be altered. Thus, the application of an electrical bias to a piezoelectric material layer coupled to the photodetector can be used to modify or tune the bandgap of the active layer in the photodetector. Accordingly, monolithic integration of a monocrystalline piezoelectric material layer with a photodetector structure provides a cost-efficient, highly-tunable photodetector which exhibits improved performance over the prior art in a variety of optical communications applications.

Referring once again to FIG. 2A, in accordance with an embodiment of the invention, a monocrystalline piezoelectric material layer 106 is monolithically-integrated with an optical device 110 of a tunable device structure 100. Piezoelectric material layer 106 is preferably an epitaxially-grown monocrystalline material which is capable of generating mechanical stress in response to an applied voltage. In one embodiment, piezoelectric material layer 106 is a dielectric material comprising a cubic crystal structure. Materials that are suitable for piezoelectric material layer 106 include barium titanate (BaTiO₃) and lead zirconium titanate (Pb(Zr,Ti)O₃). Other suitable materials may include lithium niobate, lithium tantalate, zinc oxide, and lead lanthanum zirconate titanate (Pb(La,Zr,Ti)O₃). Piezoelectric material layer 106 may have a thickness of about 100 Å to about 10 μm and preferably has a thickness of about 1000 Å to about 1 μm.

Template layer 108 is a monocrystalline material layer which provides lattice compensation when the lattice constant of piezoelectric material layer 106 cannot be adequately matched to the lattice constant of a first monocrystalline material layer of the overlying optical device 110. Accordingly, template layer 108 promotes the initiation of epitaxial growth of the first monocrystalline material layer of optical device 110 on the piezoelectric material layer 106. Template layer 108 is preferably an epitaxially-grown monocrystalline material layer which is formed of a semiconductor or compound semiconductor material. The material for template layer 108 can be selected, as desired, for a particular semiconductor structure or application. For example, the template layer 108 may comprise a compound semiconductor material selected from any of the Group IIIA and VA elements (III-V semiconductor compounds), mixed III-V compounds, Group II(A or B) and VIA elements (II-VI semiconductor compounds), and mixed II-VI compounds. Examples of such compound semiconductor materials include gallium arsenide (GaAs), gallium indium arsenide (GaInAs), gallium aluminum arsenide (GaAlAs), indium phosphide (InP), cadmium sulfide (CdS), mercury cadmium telluride (HgCdTe), zinc selenide (ZnSe), zinc sulfur selenide (ZnSSe), and the like. However, template layer 108 may also comprise other semiconductor materials, metals, or nonmetal materials which are used in the formation of semiconductor structures, devices, and/or integrated circuits. Template layer 108 may have a thickness of about 10 Å to about 1 μm and preferably has a thickness of about 500 Å to about 0.5 μm.

As previously mentioned, optical device 110 may comprise either a laser structure or a photodetector structure. Optical device 110 may be comprised of any suitable semiconductor material. In one embodiment, optical device 110 comprises a plurality of epitaxially-grown monocrystalline material layers, wherein each layer is formed of a semiconductor or compound semiconductor material. The material for optical device 110 can be selected, as desired, for a particular semiconductor structure or application. For example, the optical device 110 may comprise compound semiconductor materials selected from any of the Group IIIA and VA elements (III-V semiconductor compounds), mixed III-V compounds, Group II(A or B) and VIA elements (II-VI semiconductor compounds), and mixed II-VI compounds. Examples of such compound semiconductor materials include gallium arsenide (GaAs), gallium indium arsenide (GaInAs), gallium aluminum arsenide (GaAlAs), indium phosphide (InP), cadmium sulfide (CdS), mercury cadmium telluride (HgCdTe), zinc selenide (ZnSe), zinc sulfur selenide (ZnSSe), and the like. However, optical device 110 may also comprise other semiconductor materials, metals, or non-metal materials which are used in the formation of semiconductor structures, devices, and/or integrated circuits. Optical device 110 comprises an overall thickness of about 0.5-20 μm and preferably a thickness of about 7-10 μm.

Referring now to FIG. 2B, in accordance with one embodiment of the invention, structure 100 may also include an amorphous intermediate layer 112 positioned between substrate 102 and buffer layer 104. In one embodiment, amorphous intermediate layer 112 comprises an oxide formed at the interface between substrate 102 and the buffer layer 104 through the oxidation of the surface of the substrate 102 during the growth of the buffer layer 104. In an exemplary embodiment, amorphous intermediate layer 112 comprises a silicon oxide. Amorphous intermediate layer 112 is preferably of sufficient thickness to relieve any strain attributed to lattice mismatch between the lattice constants of substrate 102 and buffer layer 104. By relieving any strain in the buffer layer 104, amorphous intermediate layer 112 promotes the growth of a high-quality monocrystalline piezoelectric material layer 106 over the buffer layer 104. The combined thickness of buffer layer 104 and amorphous intermediate layer 112 may be about 20-1000 Å and preferably is about 50-100 Å.

In another exemplary embodiment, structure 100 includes an amorphous layer (not shown) rather than an accommodating buffer layer 104 and an amorphous intermediate layer 112. An amorphous layer may be formed by first forming an accommodating buffer layer and an amorphous intermediate layer in a similar manner to that described above. The accommodating buffer layer is then exposed to an anneal process to convert the monocrystalline accommodating buffer layer to an amorphous layer. An amorphous layer formed in this manner comprises materials from both the accommodating buffer layer and the amorphous intermediate layer, which layers may or may not amalgamate. Thus, the final amorphous layer may actually comprise one or two amorphous layers. The formation of such an amorphous layer between substrate 102 and the subsequent monocrystalline piezoelectric material layer 106 relieves any lattice strain between the substrate 102 and the piezoelectric material layer 106 and provides a true compliant substrate for subsequent processing, such as the formation of optical device 110, for example. If structure 100 does not include an amorphous layer, such as amorphous intermediate layer 112 for example, the materials forming substrate 102 and buffer layer 104 are preferably substantially lattice matched to ensure the fabrication of a high-quality optical device.

In another embodiment, an electrode layer 111 may be deposited over the optical device 110 and patterned to form electrode(s) which may be used to operate optical device 110 and to tune the optical device 110 piezoelectrically. Integrated circuits (not shown) may also be formed partially or wholly within substrate 102 and coupled via interconnects to the electrode(s) of layer 111 to control the operation of the optical device 110.

FIGS. 4A and 4B schematically illustrate a cross-sectional view of an optoelectronic device structure 200 in accordance with a further embodiment of the invention. Structure 200 is similar to the previously described device structure 100 of FIGS. 2A and 2B, except that an exemplary optical device, specifically a laser structure 210, is illustrated. FIG. 4A illustrates a portion of a semiconductor structure 200 which comprises a monocrystalline substrate 202, a monocrystalline accommodating buffer layer 204, a monocrystalline piezoelectric material layer 206, a monocrystalline template layer 208, and a laser structure 210. Substrate 202 and layers 204, 206, and 208 are substantially as described above with reference to substrate 102 and layers 104, 106, and 108, respectively, of FIG. 2A. Specifically, substrate 202 and layers 204, 206, and 208 may comprise any of the materials described above with reference to substrate 102 and layers 104, 106, and 108, respectively.

Laser structure 210 may include any suitable laser structure, such as an edge-emitting laser structure or a surface-emitting laser structure, for example. In an exemplary embodiment, laser structure 210 comprises a surface-emitting laser structure including a monocrystalline active layer 216 positioned between a first reflective mirror structure 214 and a second reflective mirror structure 218. In one exemplary embodiment, as illustrated in FIG. 4B, first mirror structure 214 is formed of repeating pairs of a first monocrystalline material layer 214a and a second monocrystalline material layer 214b. First mirror structure 214 may comprise about 15-100 repeating pairs of layers 214a and 214b and preferably comprises about 20-50 repeating pairs. Second reflective mirror structure 218 is likewise formed of repeating pairs of a third monocrystalline material layer 218a and a fourth monocrystalline material layer 218b. Second mirror structure 218 may comprise about 15-100 repeating pairs of layers 218a and 218b and preferably comprises about 20-50 repeating pairs. To fabricate a relatively defect-free reflective mirror, it is preferable that first monocrystalline material layers 214a and second material layers 214b have lattice constants that are closely matched or, alternatively, upon rotation of one crystal orientation with respect to the other crystal orientation, are capable of achieving a substantial match in lattice constants. Likewise, it is preferable that third monocrystalline material layers 218a and fourth monocrystalline layers 218b have lattice constants that are closely matched or, alternatively, upon rotation of one crystal orientation with respect to the other crystal orientation, are capable of achieving a substantial match in lattice constants.

First monocrystalline material layers 214a of first mirror 214 are preferably formed of a semiconductor or compound semiconductor material. Material for first monocrystalline material layers 214a may be selected for its crystalline compatibility with the overlying second monocrystalline material layers 214b. For example, first monocrystalline material layers 214a may be formed of material selected from any of the Group IIIA and VA elements (III-V semiconductor compounds), mixed III-V compounds, Group II(A or B) and VIA elements (II-VI semiconductor compounds), and mixed II-VI compounds. Examples include gallium arsenide (GaAs), gallium antimonide (GaSb), indium gallium arsenide (InGaAs), gallium aluminum arsenide (GaAlAs), aluminum gallium antimonide (AlGaSb), indium phosphide (InP), indium gallium arsenic phosphide (InGaAsP), indium aluminum gallium arsenide (InAlGaAs), cadmium sulfide (CdS), cadmium mercury telluride (CdHgTe), zinc selenide (ZnSe), zinc sulfur selenide (ZnSSe), lead selenide (PbSe), lead telluride (PbTe), lead sulfide selenide (PbSSe), and the like. First monocrystalline material layers 214a each has a thickness of about 100 Å to about 0.5 μm and preferably has a thickness of about 500-1500 Å.

The material for second monocrystalline material layers 214b of first mirror 214 may be selected for its crystalline compatibility with both the underlying first monocrystalline material layers 214a and the overlying active layer 216. For example, second monocrystalline material layers 214b may be formed of material selected from any of the Group IIIA and VA elements (III-V semiconductor compounds), mixed III-V compounds, Group II(A or B) and VIA elements (II-VI semiconductor compounds), and mixed II-VI compounds. Examples include gallium arsenide (GaAs), gallium antimonide (GaSb), indium gallium arsenide (InGaAs), gallium aluminum arsenide (GaAlAs), aluminum gallium antimonide (AlGaSb), indium phosphide (InP), indium gallium arsenic phosphide (InGaAsP), indium aluminum gallium arsenide (InAlGaAs), cadmium sulfide (CdS), cadmium mercury telluride (CdHgTe), zinc selenide (ZnSe), zinc sulfur selenide (ZnSSe), lead selenide (PbSe), lead telluride (PbTe), lead sulfide selenide (PbSSe), and the like. Second monocrystalline material layers 214b each has a thickness of about 100 Å to about 0.5 μm and preferably has a thickness of about 500-1500 Å.

Active layer 216 is preferably an epitaxially-grown monocrystalline material layer which is formed of a semiconductor or compound semiconductor material selected for a desired output wavelength of the device structure 200. The material for active layer 216 may comprise a compound semiconductor material selected from any of the Group IIIA and VA elements (III-V semiconductor compounds), mixed III-V compounds, Group II(A or B) and VIA elements (II-VI semiconductor compounds), and mixed II-VI compounds. Examples of such compound semiconductor materials include gallium arsenide (GaAs), indium phosphide (InP), aluminum gallium arsenide (AlGaAs), indium gallium arsenide (InGaAs), indium gallium arsenic phosphide (InGaAsP), indium aluminum arsenide phosphide (InAlAsP), indium aluminum gallium arsenide (InAlGaAs), and the like. Active layer 216 has a thickness of about 500 Å to about 2 μm and preferably has a thickness of about 1000 Å to about 0.5 μm.

Second mirror 218 includes repeating pairs of third monocrystalline material layers 218a and fourth monocrystalline material layers 218b. Materials and thicknesses suitable for third monocrystalline material layers 218a include those materials and thicknesses described above as suitable for first monocrystalline material layers 214a. Similarly, materials and thicknesses suitable for fourth monocrystalline material layers 218b include those materials and thicknesses described above as suitable for second monocrystalline material layers 214b. Third monocrystalline material layers 218a may be formed of the same material and be of the same thickness as first monocrystalline material layers 214a or may be formed of a different semiconductor material and be of a different thickness. Similarly, fourth monocrystalline material layers 218b may be formed of the same material and be of the same thickness as second monocrystalline material layers 214b or may be formed of a different semiconductor material and be of a different thickness.

In accordance with another embodiment of the invention, structure 200 may optionally include an amorphous intermediate layer 212 positioned between substrate 202 and buffer layer 204. The amorphous intermediate layer 212 may comprise any the materials previously described with reference to layer 112 of FIG. 2B. Additionally, structure 200 may comprise an amorphous layer, as described above, rather than an amorphous intermediate layer 212. If structure 200 does not include an amorphous layer, such as amorphous intermediate layer 212 for example, the substrate 202 and buffer layer 204 are preferably substantially lattice matched to ensure the fabrication of a high-quality laser structure.

In another embodiment, an electrode layer 211 may be deposited over a final monocrystalline material layer 218b of laser structure 210 and patterned to form electrode(s) which may be used to operate laser structure 210 and to tune the laser structure 210 piezoelectrically. Integrated circuits (not shown) may also be formed partially or wholly within substrate 202 and coupled via interconnects to the electrode(s) of layer 211 to control the operation of the laser structure 210.

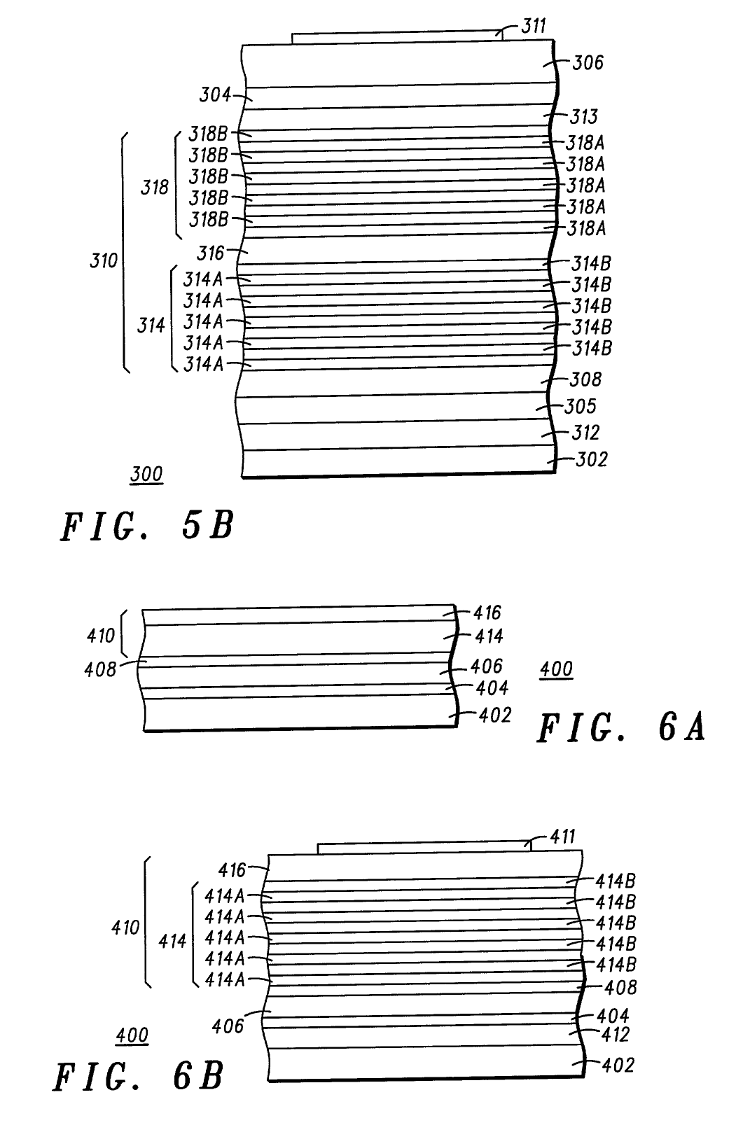

FIG. 5A illustrates a cross-sectional view of another exemplary embodiment of a portion of a tunable optoelectronic device structure 300 in accordance with the present invention. Structure 300 is similar to the previously described semiconductor structure 100, except that the monocrystalline piezoelectric material layer 306 is positioned above an optical device rather than below it, the optical device is specifically a laser structure 310, and an additional monocrystalline accommodating buffer layer 305 is positioned below the laser structure 310. In particular, tunable device structure 300 includes a monocrystalline substrate 302, a first monocrystalline accommodating buffer layer 305 positioned over substrate 302, a laser structure 310 positioned over first buffer layer 305, a second monocrystalline accommodating buffer layer 304 positioned over laser structure 310, and a monocrystalline piezoelectric material layer 306 positioned over the second buffer layer 304. In accordance with one embodiment of the invention, structure 300 also includes a monocrystalline template layer 308 positioned between first buffer layer 305 and the laser structure 310.

Substrate 302 is substantially similar to substrate 102 of FIGS. 2A-2B and may comprise any of the materials described above with reference to substrate 102. First accommodating buffer layer 305 and second accommodating buffer layer 304 are substantially similar to accommodating buffer layer 104 of FIGS. 2A-2B, and each may comprise any of the materials described above with reference to buffer layer 104. Laser structure 310 is substantially similar to the laser structure 210 of FIGS. 4A and 4B and may be formed in the manner described above using any of the materials previously described with reference to laser structure 210. Likewise, piezoelectric material layer 306 is substantially similar to piezoelectric material layer 106 of FIGS. 2A and 2B and may comprise any of the materials described above with reference to piezoelectric material layer 106. Additionally, if structure 300 includes a template layer 308, template layer 308 is substantially similar to template layer 108 of FIGS. 2A and 2B and may comprise any of the materials described above with reference to template layer 108.

Referring now to FIG. 5B, in accordance with another embodiment of the invention, laser structure 310 comprises a monocrystalline active layer 316 positioned between a first reflective mirror structure 314 and a second reflective mirror structure 318. Active layer 316 may comprise any of the materials described above with reference to active layer 216 of FIG. 2B. In one embodiment, first mirror structure 314 is formed of repeating pairs of a first monocrystalline material layer 314a and a second monocrystalline material layer 314b. Second reflective mirror structure 318 is likewise formed of repeating pairs of a third monocrystalline material layer 318a and a fourth monocrystalline material layer 318b. First, second, third, and fourth monocrystalline material layers 314a, 314b, 318a, and 318b may be formed in the manner described above with reference to layers 214a, 214b, 218a, and 218b, respectively, of FIG. 4B, using any of the materials previously described with reference to each of these layers.

In accordance with a further embodiment, structure 300 may also include a first amorphous intermediate layer 312 positioned between substrate 302 and first buffer layer 305. First amorphous intermediate layer 312 is substantially similar to amorphous intermediate layer 112 of FIG. 2B and may comprise any of the materials described above with reference to amorphous intermediate layer 112. If structure 300 does not include a first amorphous intermediate layer 312, the materials forming substrate 302 and first buffer layer 305 are preferably substantially lattice matched to ensure the fabrication of a high-quality laser structure.

In another embodiment, structure 300 may also include a second amorphous intermediate layer 313 positioned between a final fourth monocrystalline material layer 318b and second buffer layer 304. The second amorphous intermediate layer 313 is grown on a final monocrystalline material layer of laser structure 310 at the interface of the final monocrystalline material layer and the second buffer layer 304 through the oxidation of the final monocrystalline material layer during the growth of the second buffer layer 304. The second amorphous intermediate layer 313 is preferably of sufficient thickness to relieve any strain attributed to lattice mismatch between the lattice constants of the final monocrystalline material layer of laser structure 310 and the second buffer layer 304. By relieving any strain in the second buffer layer 304, second amorphous intermediate layer 313 promotes the growth of a high-quality monocrystalline piezoelectric material layer 306. The combined thickness of second buffer layer 304 and the second amorphous intermediate layer 313 may be about 20-1000 Å and preferably is about 50-100 Å. If structure 300 does not include a second amorphous intermediate layer 313, the materials forming the final monocrystalline material layer of laser structure 310 and second buffer layer 304 are preferably substantially lattice matched to ensure the fabrication of a high-quality laser structure.

In another embodiment, an electrode layer 311 may be deposited over piezoelectric material layer 306 of structure 300 and patterned to form electrode(s) which may be used to operate laser structure 310 and to tune the laser structure 310 piezoelectrically. Integrated circuits (not shown) may also be formed partially or wholly within substrate 302 and coupled via interconnects to the electrode(s) of layer 311 to control the operation of the laser structure 310.

FIGS. 6A and 6B schematically illustrate a cross-sectional view of an optoelectronic device structure 400 in accordance with a further embodiment of the invention. Structure 400 is similar to the previously described device structure 200 of FIGS. 4A and 4B, except that an alternate exemplary optical device, specifically a photodetector structure 410, is illustrated. FIG. 6A illustrates a portion of a semiconductor structure 400 which comprises a monocrystalline substrate 402, a monocrystalline accommodating buffer layer 404, a monocrystalline piezoelectric material layer 406, a monocrystalline template layer 408, and a photodetector structure 410.

Substrate 402 is substantially similar to substrate 102 of FIGS. 2A-2B and may comprise any of the materials described above with reference to substrate 102. Accommodating buffer layer 404 is substantially similar to accommodating buffer layer 104 of FIGS. 2A-2B and may comprise any of the materials described above with reference to buffer layer 104. Likewise, piezoelectric material layer 406 is substantially similar to piezoelectric material layer 106 of FIGS. 2A and 2B and may comprise any of the materials described above with reference to piezoelectric material layer 106. Additionally, if structure 400 includes a template layer 408, template layer 408 is substantially similar to template layer 108 of FIGS. 2A and 2B and may comprise any of the materials described above with reference to template layer 108.

As best seen in FIG. 6B, an exemplary photodetector structure 410 comprises a monocrystalline active layer 416 positioned above a mirror structure 414 which is formed of repeating pairs of a first monocrystalline material layer 414a and a second monocrystalline material layer 414b. Specifically, active layer 416 overlies a final second monocrystalline material layer 414b. Active layer 416 and layers 414a and 414b are substantially as described above with reference to active layer 216 and layers 214a and 214b, respectively, of FIGS. 4A and 4B. Moreover, active layer 416 and layers 414a and 414b may comprise any of the materials described above with reference to active layer 216 and layers 214a and 214b, respectively, of FIGS. 4A and 4B.

In accordance with another embodiment of the invention, structure 400 may optionally include an amorphous intermediate layer 412 positioned between substrate 402 and buffer layer 404. The amorphous intermediate layer 412 may comprise any the materials previously described with reference to layer 112 of FIG. 2B. Additionally, structure 400 may comprise an amorphous layer, as described above, rather than an amorphous intermediate layer 412. If structure 400 does not include an amorphous layer, such as amorphous intermediate layer 412 for example, the substrate 402 and buffer layer 404 are preferably substantially lattice matched to ensure the fabrication of a high-quality al photodetector.

In another embodiment, an electrode layer 411 may be deposited over active layer 416 of structure 400 and patterned to form electrode(s) which may be used to operate the photodetector structure 410 and to tune the photodetector structure 410 piezoelectrically. Integrated circuits (not shown) may also be formed partially or wholly within substrate 402 and coupled via interconnects to the electrode(s) of layer 411 to control the operation of the photodetector structure 410.

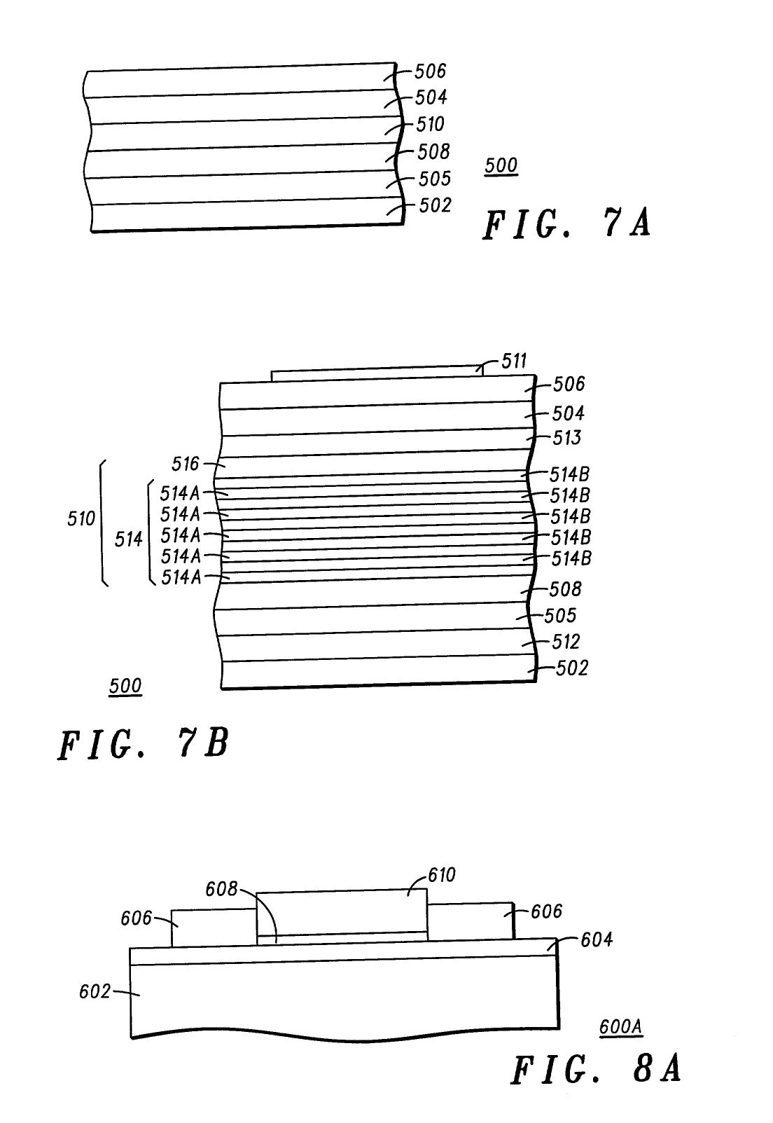

FIG. 7A illustrates a cross-sectional view of another exemplary embodiment of a portion of a tunable optoelectronic device structure 500 in accordance with the present invention. Structure 500 is similar to the previously described semiconductor structure 100, except that the monocrystalline piezoelectric material layer 506 is positioned above an optical device rather than below the optical device; the optical device is specifically a photodetector structure 510; and an additional monocrystalline accommodating buffer layer 505 is positioned below the photodetector structure 510. In particular, tunable device structure 500 includes a monocrystalline substrate 502, a first monocrystalline accommodating buffer layer 505 positioned over substrate 502, a photodetector structure 510 positioned over first buffer layer 505, a second monocrystalline accommodating buffer layer 504 positioned over photodetector structure 510, and a monocrystalline piezoelectric material layer 506 positioned over the second buffer layer 504. In accordance with one embodiment of the invention, structure 500 also includes a monocrystalline template layer 508 positioned between first buffer layer 505 and the photodetector structure 510.

Substrate 502 is substantially similar to substrate 102 of FIGS. 2A-2B and may comprise any of the materials described above with reference to substrate 102. First accommodating buffer layer 505 and second accommodating buffer layer 504 are substantially similar to accommodating buffer layer 104 of FIGS. 2A-2B, and each may comprise any of the materials described above with reference to buffer layer 104. Photodetector structure 510 is substantially similar to the photodetector structure 410 of FIGS. 6A and 6B and may be formed in the manner described above using any of the materials previously described with reference to photodetector structure 410. Likewise, piezoelectric material layer 506 is substantially similar to piezoelectric material layer 106 of FIGS. 2A and 2B and may comprise any of the materials described above with reference to piezoelectric material layer 106. Additionally, if structure 500 includes a template layer 508, template layer 508 is substantially similar to template layer 108 of FIGS. 2A and 2B and may comprise any of the materials described above with reference to template layer 108.

Photodetector structure 510 may include any suitable photodetector structure, such as a photodiode or an avalanche photodiode for example. In an exemplary embodiment, as seen in FIG. 7B, photodetector structure 510 comprises a monocrystalline active layer 516 positioned above a mirror structure 514 which is formed of repeating pairs of a first monocrystalline material layer 514a and a second monocrystalline material layer 514b. Active layer 516 and layers 514a and 514b are substantially as described above with reference to active layer 216 and layers 214a and 214b, respectively, of FIGS. 4A and 4B. Moreover, active layer 516 and layers 514a and 514b may comprise any of the materials described above with reference to active layer 216 and layers 214a and 214b, respectively, of FIGS. 4A and 4B.

In accordance with a further embodiment, structure 500 may also include a first amorphous intermediate layer 512 positioned between substrate 502 and first buffer layer 505. First amorphous intermediate layer 512 is substantially similar to amorphous intermediate layer 112 of FIG. 2B and may comprise any of the materials described above with reference to amorphous intermediate layer 112. If structure 500 does not include a first amorphous intermediate layer 512, the materials forming substrate 502 and first buffer layer 505 are preferably substantially lattice matched to ensure the fabrication of a high-quality photodetector structure.

In another embodiment, structure 500 may also include a second amorphous intermediate layer 513 positioned between active layer 516 and second buffer layer 504. The second amorphous intermediate layer 513 is grown on active layer 516 at the interface of the active layer 516 and the second buffer layer 504 through the oxidation of the active layer 516 during the growth of the second buffer layer 504. The second amorphous intermediate layer 513 is preferably of sufficient thickness to relieve any strain attributed to lattice mismatch between the lattice constants of the active layer 516 of photodetector structure 510 and the second buffer layer 504. By relieving any strain in the second buffer layer 504, second amorphous intermediate layer 513 promotes the growth of a high-quality monocrystalline piezoelectric material layer 506. The combined thickness of second buffer layer 504 and the second amorphous intermediate layer 513 may be about 20-1000 Å and preferably is about 50-100 Å. If structure 500 does not include a second amorphous intermediate layer 513, the materials forming the active layer 516 of photodetector structure 510 and second buffer layer 504 are preferably substantially lattice matched to ensure the fabrication of a high-quality photodetector structure.

In another embodiment, an electrode layer 511 may be deposited over piezoelectric material layer 506 of structure 500 and patterned to form electrode(s) which may be used to operate photodetector structure 510 and to tune the photodetector structure 510 piezoelectrically. Integrated circuits (not shown) may also be formed partially or wholly within substrate 502 and coupled via interconnects to the electrode(s) of layer 511 to control the operation of the photodetector structure 510.

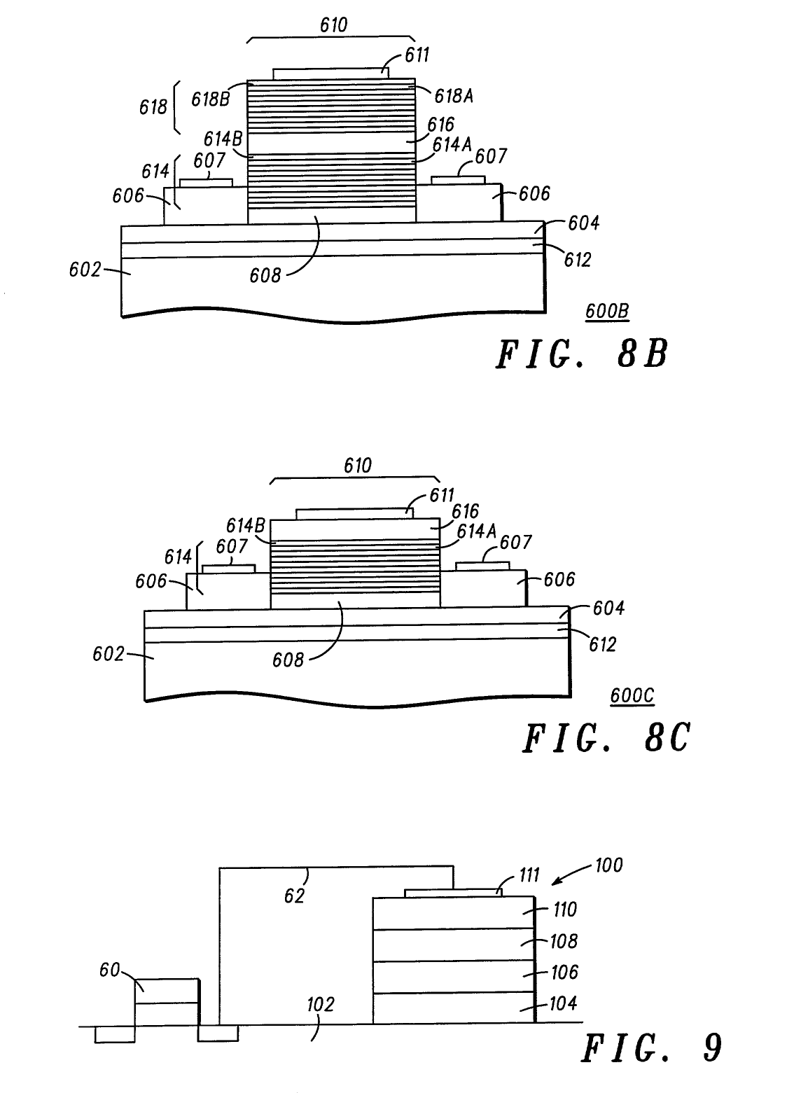

FIGS. 8A-8C illustrate cross-sectional views of additional embodiments of a portion of a tunable optoelectronic device structure in accordance with the present invention. As illustrated in FIG. 8A, tunable device structure 600A includes a monocrystalline substrate 602, a monocrystalline accommodating buffer layer 604 positioned over substrate 602, an optical device 610 positioned over the monocrystalline buffer layer 604, a monocrystalline template layer 608 positioned over buffer layer 604 and underlying optical device 610, and a monocrystalline piezoelectric material layer 606 overlying buffer layer 604 and positioned adjacent to optical device 610. Though the embodiment depicted in FIG. 8A includes a piezoelectric material layer 606 which is contacting optical device 610, it will be appreciated that other embodiments can include a piezoelectric material layer which does not contact optical device 610 but is still adjacent to optical device 610. As described in greater detail below, optical device 610 may comprise either a laser structure or a photodetector structure. An alternate embodiment of structure 600 may also include an amorphous intermediate layer 612 positioned between substrate 602 and buffer layer 604.

Substrate 602 is substantially similar to substrate 102 of FIGS. 2A-2B and may comprise any of the materials described above with reference to substrate 102. Accommodating buffer layer 604 is substantially similar to accommodating buffer layer 104 of FIGS. 2A-2B and may comprise any of the materials described above with reference to buffer layer 104. Likewise, piezoelectric material layer 606 is substantially similar to piezoelectric material layer 106 of FIGS. 2A and 2B and may comprise any of the materials described above with reference to piezoelectric material layer 106. Additionally, if structure 600 includes a template layer 608, template layer 608 is substantially similar to template layer 108 of FIGS. 2A and 2B and may comprise any of the materials described above with reference to template layer 108.

Referring now to FIG. 8B, in accordance with an embodiment of the invention, an exemplary tunable device structure 600B includes an optical device 610 comprising a laser structure. Suitable laser structures may include edge-emitting laser structures and surface-emitting laser structures, for example. In one embodiment, optical device 510 comprises a monocrystalline active layer 616 positioned between a first reflective mirror structure 614 and a second reflective mirror structure 618. Active layer 616 may comprise any of the materials described above with reference to active layer 216 of FIG. 2B. In one embodiment, first mirror structure 614 is formed of repeating pairs of a first monocrystalline material layer 614a and a second monocrystalline material layer 614b, as described above in greater detail with reference to mirror structure 214 and layer 214a and 214b of FIG. 4B. Second reflective mirror structure 618 is likewise formed of repeating pairs of a third monocrystalline material layer 618a and a fourth monocrystalline material layer 618b, as described above in greater with reference to mirror structure 218 and layer 218a and 218b of FIG. 4B. The first, second, third, and fourth monocrystalline material layers 614a, 614b, 618a, and 618b may be formed in the manner described above with reference to layers 214a, 214b, 218a, and 218b, respectively, of FIG. 4B, using any of the materials previously described with reference to each of these layers.

Referring now to FIG. 8C, in accordance with another embodiment of the invention, an exemplary tunable device structure 600C includes an optical device 610 comprising a photodetector structure. Suitable photodetector structures may include photodiodes and avalanche photodiodes, for example. In one embodiment, optical device 510 comprises a monocrystalline active layer 616 positioned over a mirror structure 614. Active layer 616 may comprise any of the materials described above with reference to active layer 416 of FIG. 6B. In one embodiment, mirror structure 614 is formed of repeating pairs of a first monocrystalline material layer 614a and a second monocrystalline material layer 614b, as described above in greater detail with reference to mirror structure 414 and layers 414a and 414b of FIG. 6B. First and second monocrystalline material layers 414a and 414b may be formed in the manner described above with reference to layers 414a and 414b, respectively, of FIG. 6B, using any of the materials previously described with reference to each of these layers.

In accordance with another embodiment of the invention, structures 600B and 600C, as depicted in FIGS. 8B and 8C, may optionally include an amorphous intermediate layer 612 positioned between substrate 602 and buffer layer 604. The amorphous intermediate layer 612 may comprise any the materials previously described with reference to layer 112 of FIG. 2B. Additionally, structures 600B and 600C may comprise an amorphous layer, as described above, rather than an amorphous intermediate layer 612. If either of structures 600B and 600C does not include an amorphous layer, such as amorphous intermediate layer 612 for example, the substrate 602 and buffer layer 604 are preferably substantially lattice matched to ensure the fabrication of a high-quality optical device 610.

In another embodiment, as depicted in FIGS. 8B and 8C, electrode layers 607 and 611 may be deposited over piezoelectric material layer 606 and optical device 610, respectively, and patterned to form electrode(s) which may be used to operate the optical device 610 and to tune the optical device 610 piezoelectrically. Integrated circuits (not shown) may also be formed partially or wholly within substrate 602 and coupled via interconnects to the electrode(s) of layers 607 and 611 to control the operation of the optical device 610.

In accordance with the invention, any of structures 100, 200, 300, 400, 500, or 600A-600C may be coupled to a CMOS device to form an optoelectronic integrated circuit. As illustrated in FIG. 9, an optical device, such as optical device 100 for example, may be coupled to a CMOS device 60 via any suitable electrical connection 62 to form an optoelectronic integrated circuit. CMOS device 60 may comprise at least one device, such as a MOSFET, which may formed in accordance with semiconductor processing methods that are well-known and widely practiced in the semiconductor industry.

A composite integrated circuit may include components that provide electrical isolation when electrical signals are applied to the composite integrated circuit. The composite integrated circuit may include a pair of optical components, such as an optical source component and an optical detector component. An optical source component may be a light generating semiconductor device, such as an optical laser (e.g., the laser structure illustrated in FIG. 2B), a photo emitter (e.g., the photodetector structure illustrated in FIG. 7B), a diode, and the like. An optical detector component may be a light-sensitive semiconductor junction device, such as a photodetector, a photodiode, a bipolar junction, a transistor, and the like.

A composite integrated circuit may include processing circuitry that is formed at least partly in the Group IV semiconductor portion of the composite integrated circuit. The processing circuitry is configured to communicate with circuitry external to the composite integrated circuit. The processing circuitry may be electronic circuitry, such as a microprocessor, RAM, logic device, decoder, and the like.

For the processing circuitry to communicate with external electronic circuitry, the composite integrated circuit may be provided with electrical signal connections to the external electronic circuitry. The composite integrated circuit may have internal optical communications connections for connecting the processing circuitry in the composite integrated circuit to the electrical connections with the external circuitry. Optical components in the composite integrated circuit may provide the optical communications connections which may electrically isolate the electrical signals in the communications connections from the processing circuitry. Together, the electrical and optical communications connections may be for communicating information, such as data, control, timing, and the like.

A pair of optical components (an optical source component and an optical detector component) in the composite integrated circuit may be configured to pass information. Information that is received or transmitted between the optical pair may be from or for the electrical communications connection between the external circuitry and the composite integrated circuit. The optical components and the electrical communications connection may form a communications connection between the processing circuitry and the external circuitry while providing electrical isolation for the processing circuitry. If desired, a plurality of optical component pairs may be included in the composite integrated circuit for providing a plurality of communications connections and for providing isolation. For example, a composite integrated circuit receiving a plurality of data bits may include a pair of optical components for the communication of each data bit.

In operation, for example, an optical source component in a pair of components may be configured to generate light (e.g., photons) based on the reception of electrical signals from an electrical signal connection with the external circuitry. An optical detector component in the pair of components may be optically connected to the source component to generate electrical signals based on the detection of light generated by the optical source component. Information that is communicated between the source and the detector components may be digital or analog.

If desired, the reverse of this configuration may be used. An optical source component that is responsive to the on-board processing circuitry may be coupled to an optical detector component, such that the optical source component generates an electrical signal for use in communications with external circuitry. A plurality of such optical component pair structures may be used for providing two-way connections. In some applications where synchronization is desired, a first pair of optical components may be coupled to provide data communications and a second pair may be coupled for communicating synchronization information.

For clarity and brevity, the optical device components that are discussed above are discussed primarily in the context of optical device components that have been formed in a compound semiconductor portion of a composite integrated circuit. In application, the optical device components may be formed in many suitable ways (e.g., formed from silicon, etc.).

A composite integrated circuit typically will have an electric connection for a power supply and a ground connection. The power and ground connections are in addition to the communications connections that are discussed above. Processing circuitry in a composite integrated circuit may include electrically isolated communications connections and include electrical connections for power and ground. In most known applications, power supply and ground connections are usually well-protected by circuitry to prevent harmful external signals from reaching the composite integrated circuit. A communications ground may be isolated from the ground signal in communications connections that use a ground communications signal.

The following non-limiting, illustrative examples represent various combinations of materials which may be used in any of structures 100, 200, 300, 400, 500, and 600A-600C in accordance with alternative embodiments of the invention. For simplicity and clarity, Example 1 refers to structure 200, Example 2 refers to structure 300, and Example 3 refers to structure 400, though it will be appreciated that the materials described in any of these examples may be implemented in any of the structural embodiments described above. The examples are merely illustrative, and the invention is not intended to be limited to these examples.

### EXAMPLE 1

In accordance with one embodiment of the invention, monocrystalline substrate 202 is a <100> oriented silicon substrate. The silicon substrate can be used, for example, in making complementary metal oxide semiconductor (CMOS) integrated circuits, as commonly practiced in the semiconductor industry. In accordance with this embodiment, accommodating buffer layer 204 is a monocrystalline layer of barium titanate (BaTiO₃), strontium titanate (SrTiO₃), or strontium barium titanate (SrₓBa₁₋ₓTiO₃, where the value of x ranges from 0 to 1), and the amorphous intermediate layer 212 is a layer of silicon oxide (SiOₓ) formed at the interface between the silicon substrate and the accommodating buffer layer. The value of x is selected to obtain one or more lattice constants closely matched to a corresponding lattice constant of the subsequently formed piezoelectric material layer 206. The accommodating buffer layer can have a thickness of about 2-100 nanometers (nm) and preferably has a thickness of about 3-10 nm. In general, it is desirable to have an accommodating buffer layer thick enough to isolate the piezoelectric material layer from the substrate to obtain the desired electrical properties. Layers thicker than about 100 nm usually provide little additional benefit while increasing cost unnecessarily; however, thicker layers may be fabricated, if needed. The amorphous intermediate layer of silicon oxide can have a thickness of about 0.5-5 nm and preferably has a thickness of about 1-2 nm.

In accordance with this embodiment of the invention, the piezoelectric material layer 206 is a layer of Pb(Zr,Ti)O₃ having a thickness of about 100 Å to about 10 μm and preferably having a thickness of about 1000 Å to about 1 μm. The thickness of the piezoelectric material layer generally depends upon the thickness of subsequent material layers as well as the mechanical stiffness of those layers.

In further accordance with this exemplary embodiment, first monocrystalline material layers 214a and third monocrystalline material layers 218a are monocrystalline material layers of AlGaAs. First monocrystalline material layers 214a and second monocrystalline material layers 218a typically have a thickness of about 400-600 Å. The thickness of these layers generally depends upon the particular application for which the layer is being prepared. To facilitate the epitaxial growth of the first monocrystalline layer 214a on the monocrystalline piezoelectric material layer 206, a template layer 208 is formed by capping the piezoelectric layer. The template layer is preferably about 1-10 atomic monolayers of Ti—As, Sr—O—As, Sr—Ga—O, or Sr—Al—O. By way of a preferred example, 1-2 atomic monolayers of Ti—As or Sr—Ga—O have been successfully demonstrated to grow GaAs layers.

Active layer 216 is a monocrystalline material layer of GaAs or AlGaAs having a thickness of about 1000 Å to about 0.5 μm and preferably having a thickness of about 2500 Å.

Second monocrystalline material layers 214b and fourth monocrystalline material layers 218b are monocrystalline material layers of AlGaAs which have a different aluminum content than the layers 214a and 218a. That is, AlGaAs layers 214b and 218b either have a greater or lesser molar concentration of aluminum than AlGaAs layers 214a and 218a. Second monocrystalline material layers 214b and fourth monocrystalline material layers 218b typically have a thickness of about 100-2000 Å and preferably have a thickness of about 400-600 Å.

### EXAMPLE 2

In accordance with another embodiment of the invention, monocrystalline substrate 302 is a silicon substrate as described above. The first accommodating buffer layer 305 is a monocrystalline oxide layer formed of strontium zirconate (SrZrO₃), barium zirconate (BaZrO₃), strontium hafnate (SrHfO₃), barium hafnate (BaHfO₃), or barium tin oxide (BaSnO₃), in either a cubic or orthorhombic phase, with a first amorphous intermediate layer 312 of silicon oxide formed at the interface between the silicon substrate and the first accommodating buffer layer. The first accommodating buffer layer can have a thickness of about 2-100 μm. Preferably, the first accommodating buffer layer has a thickness of at least about 5 nm, to ensure adequate crystalline and surface quality. For example, a monocrystalline oxide layer of BaZrO₃ grown at a temperature of about 700° C. results in a crystalline oxide lattice structure exhibiting a 45° rotation with respect to the silicon substrate's lattice structure.

A first accommodating buffer layer formed of these zirconate or hafnate materials is suitable for the growth of a subsequent first monocrystalline material layer 314a which comprises a compound semiconductor material in the indium phosphide (InP) system. In this embodiment, first monocrystalline material layers 314a and third monocrystalline material layers 318a are formed of a compound semiconductor material comprising, for example, InP or AlAsSb having a thickness of about 100 Å to about 0.5 μm and preferably having a thickness of about 800-1500 Å.

A suitable template layer 308 for this structure is about 1-10 atomic monolayers of zirconium-phosphorus (Zr—P), zirconium-arsenic (Zr—As), hafnium-arsenic (Hf—As), hafnium-phosphorus (Hf—P), strontium-oxygen-arsenic (Sr—O—As), strontium-oxygen-phosphorus (Sr—O—P), barium-oxygen-arsenic (Ba—O—As), indium-strontium-oxygen (In—Sr—O), or barium-oxygen-phosphorus (Ba—O—P) and preferably is about 1-2 atomic monolayers of one of these materials. By way of an example, for a barium zirconate first accommodating buffer layer, the surface is terminated with about 1-2 atomic monolayers of zirconium followed by deposition of about 1-2 atomic monolayers of arsenic to form a Zr—As template layer. A first monocrystalline material layer 314a of a compound semiconductor material from the indium phosphide system is then grown on the template layer. The resulting lattice structure of the compound semiconductor material exhibits a 45° rotation with respect to the accommodating buffer layer lattice structure as well as a lattice mismatch to <100> InP of less than about 2.5% and preferably of less than about 1%.

Second monocrystalline material layers 314b and fourth monocrystalline material layers 318b are monocrystalline material layers of InGaAsP or GaAsSb. Second monocrystalline material layers 314a and fourth monocrystalline material layers 318b typically have a thickness of about 100 Å to about 0.5 μm and preferably have a thickness of about 800-1500 Å.

In accordance with this embodiment, second accommodating buffer layer 304 is a monocrystalline layer of SrₓBa₁₋ₓTiO₃, where the value of x ranges from 0 to 1, and the second amorphous intermediate layer 313 is a metal oxide layer formed at the interface between the final fourth monocrystalline material layer 318b and the second accommodating buffer layer 304. The value of x is selected to obtain one or more lattice constants closely matched to a corresponding lattice constant of the subsequently formed piezoelectric material layer 306. The second accommodating buffer layer can have a thickness of about 2-100 nm and preferably has a thickness of about 5-10 nm. The amorphous intermediate layer can have a thickness of about 0.5-5 nm and preferably has a thickness of about 1-2 nm.

The piezoelectric material layer 306 is a layer of Pb(Zr,Ti)O₃ having a thickness of about 100 Å to about 10 μm and preferably having a thickness of about 1000 Å to about 1 μm.

### EXAMPLE 3

In accordance with another embodiment of the invention, monocrystalline substrate 402 is a <100> oriented silicon substrate. The silicon substrate can be used, for example, in making complementary metal oxide semiconductor (CMOS) integrated circuits, as commonly practiced in the semiconductor industry. In accordance with this embodiment, accommodating buffer layer 404 is a monocrystalline layer of barium titanate (BaTiO₃), strontium titanate (SrTiO₃), or strontium barium titanate (SrₓBa₁₋ₓTiO₃, where the value of x ranges from 0 to 1), and the amorphous intermediate layer 412 is a layer of silicon oxide (SiOₓ) formed at the interface between the silicon substrate and the accommodating buffer layer. The value of x is selected to obtain one or more lattice constants closely matched to a corresponding lattice constant of the subsequently formed piezoelectric material layer 406. The accommodating buffer layer can have a thickness of about 2-100 nanometers (nm) and preferably has a thickness of about 3-10 nm. In general, it is desirable to have an accommodating buffer layer thick enough to isolate the piezoelectric material layer from the substrate to obtain the desired electrical properties. Layers thicker than about 100 nm usually provide little additional benefit while increasing cost unnecessarily; however, thicker layers may be fabricated, if needed. The amorphous intermediate layer of silicon oxide can have a thickness of about 0.5-5 nm and preferably has a thickness of about 1-2 nm.

In accordance with this embodiment of the invention, the piezoelectric material layer 406 is a layer of Pb(Zr,Ti)O₃ having a thickness of about 100 Å to about 10 μm and preferably having a thickness of about 1000 Å to about 1 μm.

In further accordance with this exemplary embodiment, first monocrystalline material layers 414a are monocrystalline material layers of AlGaAs. First monocrystalline material layers 414a typically have a thickness of about 400-600 Å. The thickness generally depends upon the particular application for which the layer is being prepared. To facilitate the epitaxial growth of the first monocrystalline layer 414a on the monocrystalline piezoelectric material layer 406, a template layer 408 is formed by capping the piezoelectric layer 406. The template layer 408 is preferably about 1-10 atomic monolayers of Ti—As, Sr—O—As, Sr—Ga—O, or Sr—Al—O. By way of a preferred example, 1-2 atomic monolayers of Ti—As or Sr—Ga—O have been successfully demonstrated to grow GaAs layers.

Photodetector active layer 416 is a monocrystalline material layer of GaAs or AlGaAs having a thickness of about 1000 Å to about 2 μm and preferably having a thickness of about 5000 Å to about 1 μm.

Second monocrystalline material layers 414b are monocrystalline material layers of AlGaAs having a different aluminum content than layers 414a. Second monocrystalline material layers 414b typically have a thickness of about 100-2000 Å and preferably have a thickness of about 400-600 Å.

In accordance with an embodiment of the invention, the following describes an exemplary process for fabricating a piezoelectrically-tunable optical semiconductor structure, such as any of structures 100, 200, 300, 400, 500, and 600A-600C described above. The process begins by providing a monocrystalline semiconductor substrate comprising silicon or germanium. In accordance with one embodiment, a silicon wafer having a <100> orientation provides a suitable monocrystalline substrate. The substrate may be oriented on-axis or, at most, about 2°-60° off-axis. At least a portion of the semiconductor substrate has a bare surface, although other portions of the substrate, as described below, may encompass other structures. The term “bare” in this context means that the portion of the substrate surface has been cleaned to remove any oxides, contaminants, or other foreign material. As is well known, bare silicon is highly reactive and readily forms a native oxide. The term “bare” is intended to encompass such a native oxide. A thin silicon oxide may also be intentionally grown on the semiconductor substrate, although such a grown oxide is not essential to the process in accordance with the invention.

Epitaxial growth of an accommodating buffer layer overlying the monocrystalline substrate is facilitated by first removing the native oxide layer to expose the crystalline structure of the underlying substrate. An exemplary process is generally carried out by molecular beam epitaxy (MBE), although other processes, such as those outlined below, may also be used in accordance with the present invention. The native oxide can be removed by first thermally depositing a thin layer of strontium, barium, a combination of strontium and barium, or other alkaline-earth metals or combinations of alkaline-earth metals in an MBE apparatus. In the case where strontium is used, the substrate is then heated to a temperature of about 850° C. to cause the strontium to react with the native silicon oxide layer. The strontium serves to reduce the silicon oxide and leaves a silicon oxide-free surface. The resultant surface, which exhibits an ordered 2×1 structure, includes strontium, oxygen, and silicon. If an ordered 2×1 structure has not been achieved at this stage of the process, the structure may be exposed to additional strontium until an ordered 2×1 structure is obtained. The ordered 2×1 structure forms a template for the ordered growth of an overlying accommodating buffer layer, such as a monocrystalline oxide layer. The template provides favorable chemical and physical properties to nucleate the crystalline growth of an overlying layer.

In accordance with an alternate embodiment of the invention, the native silicon oxide can be reduced, and the substrate surface can be prepared for the growth of a monocrystalline oxide layer by depositing, for example, an alkaline-earth metal oxide, such as strontium oxide, strontium barium oxide, or barium oxide, onto the substrate surface by MBE at a low temperature and by subsequently heating the structure to a temperature of about 850° C. At this temperature, a solid state reaction takes place between the strontium oxide and the native silicon oxide, causing the reduction of the native silicon oxide and creating an ordered 2×1 structure with strontium, oxygen, and silicon remaining on the substrate surface. Again, this forms a template for the subsequent growth of an ordered monocrystalline buffer layer.

Following the removal of the silicon oxide from the surface of the substrate, in accordance with one embodiment of the invention, the substrate is cooled to a temperature in the range of about 200-800° C., and an accommodating buffer layer, such as a monocrystalline oxide layer of strontium barium titanate or strontium zirconate, for example, is grown on the template layer by MBE. The MBE process is initiated by opening shutters in the MBE apparatus to expose sources of the appropriate elements, such as strontium, barium, titanium, and oxygen sources in the case of growing strontium barium titanate. The partial pressure of oxygen is initially set at a minimum value to grow a layer of strontium barium titanate at a growth rate of about 0.3-0.5 nm per minute. After initiating growth of the monocrystalline oxide layer, the partial pressure of oxygen is increased above the initial minimum value. The overpressure of oxygen causes the growth of an amorphous silicon oxide layer at the interface between the underlying substrate and the growing strontium barium titanate layer. The growth of the silicon oxide layer results from the diffusion of oxygen through the growing strontium barium titanate layer to the interface where the oxygen reacts with silicon at the surface of the underlying substrate. The strontium barium titanate material grows as an ordered <100> monocrystal whose orientation is rotated by 45° with respect to the ordered 2×1 crystalline structure of the underlying substrate. Strain that otherwise might exist in the strontium barium titanate layer, due to a slight mismatch in the lattice constants of the silicon substrate and the growing crystal, is relieved by the amorphous silicon oxide intermediate layer.

After the accommodating buffer layer has been grown to the desired thickness, the buffer layer may be capped by a template layer that is conducive to the subsequent growth of an epitaxial layer of a desired monocrystalline material, such as a compound semiconductor material or a piezoelectric material. For example, to facilitate the subsequent growth of a monocrystalline compound semiconductor material layer of gallium arsenide, the strontium titanate monocrystalline layer can be capped by terminating the growth with about 1-2 atomic monolayers of titanium, about 1-2 atomic monolayers of titanium-oxygen, or about 1-2 atomic monolayers of strontium-oxygen. Following the formation of this capping layer, arsenic is deposited to form a Ti—As bond, a Ti—O—As bond, or a Sr—O—As bond. Any of these combination materials may form an appropriate template for the deposition and formation of a gallium arsenide monocrystalline layer. For example, following the formation of the template, gallium may subsequently be introduced with the arsenic, and gallium arsenide then forms. Alternatively, gallium can be deposited on the capping layer to form a Sr—O—Ga bond, and arsenic may subsequently be introduced with the gallium to form the GaAs.

Alternatively, to facilitate the subsequent growth of a monocrystalline piezoelectric material layer, such as Pb(Zr,Ti)O₃ or BaTiO₃, over an accommodating buffer layer, such as strontium titanate, the monocrystalline buffer layer can be capped by terminating the growth with about 1-2 atomic monolayers of titanium-oxygen. The sample can then be transferred to a pulsed laser deposition (PLD) system where laser ablation from a Pb(Zr,Ti)O₃ or BaTiO₃ target is used to deposit monocrystalline Pb(Zr,Ti)O₃ or BaTiO₃ overlying the monocrystalline strontium titanate layer. Alternatively, the sample with the strontium titanate monocrystalline layer can be transferred to a chemical solution decomposition (CSD) tool and the Pb(Zr,Ti)O₃ or BaTiO₃ piezoelectric material layer can be deposited overlying the strontium titanate monocrystalline layer through well-known sol-gel or metal-organic decomposition (MOD) techniques.

Each of the variations of the monocrystalline material layer and the monocrystalline accommodating buffer layer may use an appropriate template for initiating the growth of a subsequent monocrystalline material layer. For example, if the accommodating buffer layer is an alkaline-earth metal zirconate, the buffer layer can be capped by a thin layer of zirconium. The deposition of zirconium can be followed by the deposition of arsenic or phosphorus to react with the zirconium as a precursor to the deposition of indium gallium arsenide, indium aluminum arsenide, or indium phosphide, respectively. Similarly, if the monocrystalline oxide accommodating buffer layer is an alkaline-earth metal hafnate, the buffer layer can be capped by a thin layer of hafnium. The deposition of hafnium is followed by the deposition of arsenic or phosphorous to react with the hafnium as a precursor to the growth of an indium gallium arsenide, indium aluminum arsenide, or indium phosphide layer, respectively. In a similar manner, strontium titanate can be capped with a layer of strontium or strontium and oxygen, and barium titanate can be capped with a layer of barium or barium and oxygen. Each of these depositions can be followed by the deposition of arsenic or phosphorus to react with the capping material to form a template for the deposition of a monocrystalline material layer comprising compound semiconductor materials, such as indium gallium arsenide, indium aluminum gallium arsenide, aluminum gallium arsenide, indium phosphide, indium gallium arsenic phosphide, and indium aluminum arsenic phosphide. Similarly, each of the various depositions may be followed by the deposition of antimony to react with the capping material to form a template for the deposition of a monocrystalline material layer comprising compound semiconductor materials such as gallium antimonide and aluminum gallium antimonide.

The piezoelectrically-tunable semiconductor structure formed by any of the foregoing exemplary processes may be suitably integrated into a semiconductor device to form a metal oxide semiconductor (MOS) circuit.

The process described above illustrates a process for forming a piezoelectrically-tunable optical device structure comprising a silicon substrate, an optical device, such as a laser structure or a photodetector structure, and a piezoelectric material layer. While aspects of the above process are described with reference to the process of molecular beam epitaxy (MBE), any of the above-described processes may be carried out by using MBE, chemical vapor deposition (CVD), metal organic chemical vapor deposition (MOCVD), migration enhanced epitaxy (MEE), atomic layer epitaxy (ALE), physical vapor deposition (PVD), chemical solution deposition (CSD), pulsed laser deposition (PLD), or the like. Further, by such processes, other monocrystalline accommodating buffer layers, such as alkaline-earth metal titanates, zirconates, hafnates, tantalates, vanadates, ruthenates, and niobates; perovskite oxides, such as alkaline-earth metal tin-based perovskites; and lanthanum series oxides such as lanthanum aluminate, lanthanum scandium oxide, and gadolinium oxide, also can be grown. Moreover, such processes may also facilitate the deposition of other monocrystalline material layers comprising other III-V and II-VI monocrystalline compound semiconductors over the monocrystalline accommodating buffer layer.

Clearly, the above-described embodiments of the invention are merely illustrative and are not intended to limit the scope of the present invention. A multiplicity of other combinations and embodiments of the present invention are possible, and all such combinations and embodiments fall within the ambit of the appended claims. For example, the present invention includes structures and methods for fabricating material layers which form semiconductor structures, devices, and integrated circuits including other layers, such as metal and non-metal layers. More specifically, the invention includes structures and methods for forming a compliant substrate which is used in the fabrication of semiconductor structures, devices, and integrated circuits and the material layers suitable for fabricating those structures, devices, and integrated circuits. Use of the embodiments of the present invention simplifies the integration of devices that include monocrystalline layers comprising semiconductor and compound semiconductor materials, as well as other material layers that are used to form those devices, with other components that operate more effectively or are easily and/or inexpensively formed within semiconductor or compound semiconductor materials. This permits the fabrication of smaller devices, the reduction of manufacturing costs, and the increase in yield and reliability.

In accordance with one embodiment of this invention, a monocrystalline semiconductor or compound semiconductor wafer can be used in forming monocrystalline material layers over the wafer. In this manner, the wafer is essentially a “handle” wafer which is used during the fabrication of semiconductor electrical components within a monocrystalline layer overlying the wafer. Therefore, electrical components can be formed within semiconductor materials over a wafer of at least about 200 millimeters in diameter and possibly at least about 300 millimeters in diameter. Use of this type of substrate permits a relatively inexpensive “handle” wafer to overcome the fragile nature of compound semiconductor or other monocrystalline material wafers by placing these fragile materials over a comparatively more durable and easily fabricated base material. Thus, an integrated circuit can be fabricated such that all electrical components, and particularly all active electronic devices, can be formed within or using the monocrystalline material layer, even though the substrate itself may include a monocrystalline semiconductor material. Fabrication costs for compound semiconductor devices and other devices employing non-silicon monocrystalline materials should decrease, because larger substrates can be processed more economically and more readily when compared to smaller and more fragile substrates (e.g., conventional compound semiconductor wafers).

In the foregoing specification, the invention has been described with reference to specific embodiments. However, it will be appreciated that various modifications and changes can be made without departing from the scope of the present invention as set forth in the claims below. The specification and figures are to be regarded in an illustrative manner, rather than a restrictive one, and all such modifications are intended to be included within the scope of present invention. Accordingly, the scope of the invention should be determined by the appended claims and their legal equivalents, rather than by the examples given above. For example, the steps recited in any of the method or process claims may be executed in any order and are not limited to the order presented in the claims.

Benefits, other advantages, and solutions to problems have been described above with regard to specific embodiments. However, the benefits, advantages, solutions to problems, and any element(s) that may cause any benefit, advantage, solution to occur or become more pronounced are not to be constructed as critical, required, or essential features or elements of any or all of the claims. As used herein, the terms “comprises,” “comprising”, “includes”, “including”, and any other variations thereof, are intended to cover a non-exclusive inclusion, such that a process, method, article, or apparatus that comprises a list of elements does not include only those elements but may include other elements not expressly listed or inherent to such process, method, article, or apparatus.

1. A wavelength-tunable optical device structure comprising:
a monocrystalline substrate;
an accommodating buffer layer overlying said monocrystalline substrate;
a monocrystalline piezoelectric material layer overlying said accommodating buffer layer;
a template layer overlying said piezoelectric material layer; and
an optical device overlying said template layer.

2. The device structure of claim 1, wherein said monocrystalline substrate comprises material selected from the group consisting of silicon, germanium, silicon carbide, indium phosphide, silicon germanium, gallium arsenide, and indium arsenide.

3. The device structure of claim 1, wherein said monocrystalline substrate comprises silicon.

4. The device structure of claim 1, wherein said accommodating buffer layer comprises a monocrystalline oxide material selected from the group consisting of alkaline-earth metal titanates, alkaline-earth metal zirconates, alkaline-earth metal hafnates, alkaline-earth metal tantalates, alkaline-earth metal ruthenates, alkaline-earth metal niobates, and metal oxides.

5. The device structure of claim 1, wherein said accommodating buffer layer comprises material selected from the group consisting of BaTiO₃, SrTiO₃, SrₓBa₁₋ₓTiO₃ (where the value of x ranges from 0 to 1), BaZO₃, and SrZO₃.

6. The device structure of claim 1, wherein said piezoelectric material layer comprises a monocrystalline oxide material.

7. The device structure of claim 1, wherein said piezoelectric material layer comprises material selected from the group consisting of lead zirconium titanate and barium titanate.

8. The device structure of claim 1, wherein said template layer comprises one of a semiconductor material and a compound semiconductor material.

9. The device structure of claim 1, wherein said template layer comprises a material selected from the group consisting of Group III-V compounds, mixed Group III-V compounds, Group II-VI compounds, and mixed Group II-VI compounds.

10. The device structure of claim 1, wherein said optical device comprises a laser structure.

11. The device structure of claim 10, wherein said laser structure comprises:
a first reflective mirror overlying said template layer, wherein said first reflective mirror comprises a plurality of alternating first monocrystalline material layers and second monocrystalline material layers;
a monocrystalline active layer overlying a final second monocrystalline material layer of said first reflective mirror; and
a second reflective mirror overlying said active layer, wherein said second reflective mirror comprises a plurality of alternating third monocrystalline material layers and fourth monocrystalline material layers.

12. The device structure of claim 11, wherein each of said first monocrystalline material layers and said second monocrystalline material layers comprises one of a semiconductor material and a compound semiconductor material

13. The device structure of claim 11, wherein each of said third monocrystalline material layers and said fourth monocrystalline material layers comprises one of a semiconductor material and a compound semiconductor material.

14. The device structure of claim 11, wherein each of said first monocrystalline material layers, said second monocrystalline material layers, said third monocrystalline material layers, and said fourth monocrystalline material layers comprises a compound semiconductor material independently selected from the group consisting of GaAs, GaSb, InGaAs, GaAlAs, AlGaSb, InP, InGaAsP, and InAlGaAs.

15. The device structure of claim 11, wherein said active layer comprises a compound semiconductor material selected from the group consisting of GaAs, InP, AlGaAs, InGaAs, InGaAsP, InAlAsP, and InAlGaAs.

16. The device structure of claim 11, wherein each of said first monocrystalline material layers is characterized by a first lattice constant and each of said second monocrystalline material layers is characterized by a second lattice constant which is substantially lattice matched to said first lattice constant.

17. The device structure of claim 11, wherein each of said third monocrystalline material layers is characterized by a third lattice constant and each of said fourth monocrystalline material layers is characterized by a fourth lattice constant which is substantially lattice matched to said third lattice constant.

18. The device structure of claim 1, wherein said optical device comprises a photodetector structure.

19. The device structure of claim 18, wherein said photodetector structure comprises:
a mirror structure overlying said template layer, wherein said mirror structure comprises a plurality of alternating first monocrystalline material layers and second monocrystalline material layers; and
a monocrystalline active layer overlying a final second monocrystalline material layer of said mirror structure.

20. The device structure of claim 19, wherein each of said first monocrystalline material layers and said second monocrystalline material layers comprises one of a semiconductor material and a compound semiconductor material

21. The device structure of claim 19, wherein each of said first monocrystalline material layers and said second monocrystalline material layers comprises a compound semiconductor material independently selected from the group consisting of GaAs, GaSb, InGaAs, GaAlAs, AlGaSb, InP, InGaAsP, and InAlGaAs.

22. The device structure of claim 19, wherein said active layer comprises a compound semiconductor material selected from the group consisting of GaAs, InP, AlGaAs, InGaAs, InGaAsP, InAlAsP, and InAlGaAs.

23. The device structure of claim 19, wherein each of said first monocrystalline material layers is characterized by a first lattice constant and each of said second monocrystalline material layers is characterized by a second lattice constant which is substantially lattice matched to said first lattice constant.

24. The device structure of claim 1, further comprising an amorphous intermediate layer overlying said monocrystalline substrate and underlying said accommodating buffer layer.

25. The device structure of claim 24, wherein said amorphous intermediate layer comprises silicon oxide.

26. The device structure of claim 1, further comprising a portion of an MOS circuit formed in said substrate, wherein said optical device is electrically connected to said portion of an MOS circuit.

27. A wavelength-tunable optical device structure comprising:
a monocrystalline substrate;
a monocrystalline accommodating buffer layer positioned over said monocrystalline substrate;
an optical device positioned over said accommodating buffer layer;
a template layer positioned over said accommodating buffer layer and underlying said optical device; and
a monocrystalline piezoelectric material layer overlying said accommodating buffer layer and positioned adjacent to said optical device.

28. The device structure of claim 27, wherein said monocrystalline substrate comprises material selected from the group consisting of silicon, germanium, silicon carbide, indium phosphide, silicon germanium, gallium arsenide, and indium arsenide.

29. The device structure of claim 27, wherein said monocrystalline substrate comprises silicon.

30. The device structure of claim 27, wherein said accommodating buffer layer comprises a monocrystalline oxide material selected from the group consisting of alkaline-earth metal titanates, alkaline-earth metal zirconates, alkaline-earth metal hafnates, alkaline-earth metal tantalates, alkaline-earth metal ruthenates, alkaline-earth metal niobates, and metal oxides.

31. The device structure of claim 27, wherein said accommodating buffer layer comprises material selected from the group consisting of BaTiO₃, SrTiO₃, SrₓBa₁₋ₓTiO₃ (where then value of x ranges from 0 to 1), BaZO₃, and SrZO₃.

32. The device structure of claim 27, wherein said piezoelectric material layer comprises a monocrystalline oxide material.

33. The device structure of claim 27, wherein said piezoelectric material layer comprises material selected from the group consisting of lead zirconium titanate and barium titanate.

34. The device structure of claim 27, wherein said template layer comprises one of a semiconductor material and a compound semiconductor material.

35. The device structure of claim 27, wherein said template layer comprises a material selected from the group consisting of Group III-V compounds, mixed Group III-V compounds, Group II-VI compounds, and mixed Group II-VI compounds.

36. The device structure of claim 27, wherein said optical device comprises a laser structure.

37. The device structure of claim 36, wherein said laser structure comprises:
a first reflective mirror overlying said template layer, wherein said first reflective mirror comprises a plurality of alternating first monocrystalline material layers and second monocrystalline material layers;
a monocrystalline active layer overlying a final second monocrystalline material layer of said first reflective mirror; and
a second reflective mirror overlying said active layer, wherein said second reflective mirror comprises a plurality of alternating third monocrystalline material layers and fourth monocrystalline material layers.

38. The device structure of claim 37, wherein each of said first monocrystalline material layers and said second monocrystalline material layers comprises one of a semiconductor material and a compound semiconductor material

39. The device structure of claim 37, wherein each of said third monocrystalline material layers and said fourth monocrystalline material layers comprises one of a semiconductor material and a compound semiconductor material.

40. The device structure of claim 37, wherein each of said first monocrystalline material layers, said second monocrystalline material layers, said third monocrystalline material layers, and said fourth monocrystalline material layers comprises a compound semiconductor material independently selected from the group consisting of GaAs, GaSb, InGaAs, GaAlAs, AlGaSb, InP, InGaAsP, and InAlGaAs.

41. The device structure of claim 37, wherein said active layer comprises a compound semiconductor material selected from the group consisting of GaAs, InP, AlGaAs, InGaAs, InGaAsP, InAlAsP, and InAlGaAs.

42. The device structure of claim 37, wherein each of said first monocrystalline material layers is characterized by a first lattice constant and each of said second monocrystalline material layers is characterized by a second lattice constant which is substantially lattice matched to said first lattice constant.

43. The device structure of claim 37, wherein each of said third monocrystalline material layers is characterized by a third lattice constant and each of said fourth monocrystalline material layers is characterized by a fourth lattice constant which is substantially lattice matched to said third lattice constant.

44. The device structure of claim 27, wherein said optical device comprises a photodetector structure.

45. The device structure of claim 44, wherein said photodetector structure comprises:
a mirror structure overlying said template layer, wherein said mirror structure comprises a plurality of alternating first monocrystalline material layers and second monocrystalline material layers; and
a monocrystalline active layer overlying a final second monocrystalline material layer of said mirror structure.

46. The device structure of claim 45, wherein each of said first monocrystalline material layers and said second monocrystalline material layers comprises one of a semiconductor material and a compound semiconductor material

47. The device structure of claim 45, wherein each of said first monocrystalline material layers and said second monocrystalline material layers comprises a compound semiconductor material independently selected from the group consisting of GaAs, GaSb, InGaAs, GaAlAs, AlGaSb, InP, InGaAsP, and InAlGaAs.

48. The device structure of claim 45, wherein said active layer comprises a compound semiconductor material selected from the group consisting of GaAs, InP, it) AlGaAs, InGaAs, InGaAsP, InAlAsP, and InAlGaAs.

49. The device structure of claim 45, wherein each of said first monocrystalline material layers is characterized by a first lattice constant and each of said second monocrystalline material layers is characterized by a second lattice constant which is substantially lattice matched to said first lattice constant.

50. The device structure of claim 27, further comprising an amorphous intermediate layer overlying said monocrystalline substrate and underlying said accommodating buffer layer.

51. The device structure of claim 50, wherein said amorphous intermediate layer comprises silicon oxide.

52. The device structure of claim 27, further comprising a portion of an MOS circuit formed in said substrate, wherein said optical device is electrically connected to said portion of an MOS circuit.

53. A wavelength-tunable optical device structure comprising:
a monocrystalline substrate;
a first accommodating buffer layer overlying said substrate;
an optical device overlying said first accommodating buffer layer;
a second accommodating buffer layer overlying said optical device; and
a monocrystalline piezoelectric material layer overlying said second accommodating buffer layer.

54. The device structure of claim 53, wherein said monocrystalline substrate comprises material selected from the group consisting of silicon, germanium, silicon carbide, indium phosphide, silicon germanium, gallium arsenide, and indium arsenide.

55. The device structure of claim 53, wherein said monocrystalline substrate comprises silicon.

56. The device structure of claim 53, wherein each of said first accommodating buffer layer and said second accommodating buffer layer comprises a monocrystalline oxide material independently selected from the group consisting of alkaline-earth metal titanates, alkaline-earth metal zirconates, alkaline-earth metal hafnates, alkaline-earth metal tantalates, alkaline-earth metal ruthenates, alkaline-earth metal niobates, and metal oxides.

57. The device structure of claim 53, wherein each of said first accommodating buffer layer and said second accommodating buffer layer comprises a monocrystalline material independently selected from the group consisting of BaTiO₃, SrTiO₃, SrₓBa₁₋ₓTiO₃ (where the value of x ranges from 0 to 1), BaZO₃, and SrZO₃.

58. The device structure of claim 53, wherein said piezoelectric material layer comprises a monocrystalline oxide material.

59. The device structure of claim 53, wherein said piezoelectric material layer comprises material selected from the group consisting of lead zirconium titanate and barium titanate.

60. The device structure of claim 53, wherein said optical device comprises a laser structure.

61. The device structure of claim 60, wherein said laser structure comprises:
a first reflective mirror overlying said first accommodating buffer layer, wherein said first reflective mirror comprises a plurality of alternating first monocrystalline material layers and second monocrystalline material layers;
a monocrystalline active layer overlying a final second monocrystalline material layer of said first reflective mirror; and
a second reflective mirror overlying said active layer, wherein said second reflective mirror comprises a plurality of alternating third monocrystalline material layers and fourth monocrystalline material layers.

62. The device structure of claim 61, wherein each of said first monocrystalline material layers and said second monocrystalline material layers comprises one of a semiconductor material and a compound semiconductor material

63. The device structure of claim 61, wherein each of said third monocrystalline material layers and said fourth monocrystalline material layers comprises one of a semiconductor material and a compound semiconductor material.

64. The device structure of claim 61, wherein each of said first monocrystalline material layers, said second monocrystalline material layers, said third monocrystalline material layers, and said fourth monocrystalline material layers comprises a compound semiconductor material independently selected from the group consisting of GaAs, GaSb, InGaAs, GaAlAs, AlGaSb, InP, InGaAsP, and InAlGaAs.

65. The device structure of claim 61, wherein said active layer comprises a compound semiconductor material selected from the group consisting of GaAs, InP, AlGaAs, InGaAs, InGaAsP, InAlAsP, and InAlGaAs.

66. The device structure of claim 61, wherein each of said first monocrystalline material layers is characterized by a first lattice constant and each of said second monocrystalline material layers is characterized by a second lattice constant which is substantially lattice matched to said first lattice constant.

67. The device structure of claim 61, wherein each of said third monocrystalline material layers is characterized by a third lattice constant and each of said fourth monocrystalline material layers is characterized by a fourth lattice constant which is substantially lattice matched to said third lattice constant.

68. The device structure of claim 53, further comprising a first amorphous intermediate layer overlying said monocrystalline substrate and underlying said first accommodating buffer layer.

69. The device structure of claim 53, wherein said optical device comprises a photodetector structure.

70. The device structure of claim 69, wherein said photodetector structure comprises:
a mirror structure overlying said template layer, wherein said mirror structure comprises a plurality of alternating first monocrystalline material layers and second monocrystalline material layers; and
a monocrystalline active layer overlying a final second monocrystalline material layer of said mirror structure.

71. The device structure of claim 70, wherein each of said first monocrystalline material layers and said second monocrystalline material layers comprises one of a semiconductor material and a compound semiconductor material

72. The device structure of claim 70, wherein each of said first monocrystalline material layers and said second monocrystalline material layers comprises a compound semiconductor material independently selected from the group consisting of GaAs, GaSb, InGaAs, GaAlAs, AlGaSb, InP, InGaAsP, and InAlGaAs.

73. The device structure of claim 70, wherein said active layer comprises a compound semiconductor material selected from the group consisting of GaAs, InP, AlGaAs, InGaAs, InGaAsP, InAlAsP, and InAlGaAs.

74. The device structure of claim 70, wherein each of said first monocrystalline material layers is characterized by a first lattice constant and each of said second monocrystalline material layers is characterized by a second lattice constant which is substantially lattice matched to said first lattice constant.

75. The device structure of claim 68, wherein said first amorphous intermediate layer comprises silicon oxide.

76. The device structure of claim 68, further comprising a second amorphous intermediate layer overlying said laser structure and underlying said second accommodating buffer layer.

77. The device structure of claim 53, further comprising a template layer overlying said first accommodating buffer layer and underlying said laser structure.

78. The device structure of claim 77, wherein said template layer comprises one of a semiconductor material and a compound semiconductor material.

79. The device structure of claim 77, wherein said template layer comprises a material selected from the group consisting of Group III-V compounds, mixed Group III-V compounds, Group II-VI compounds, and mixed Group II-VI compounds.

80. The device structure of claim 53, further comprising a portion of an MOS circuit formed in said substrate, wherein said optical device structure is electrically connected to said portion of an MOS Circuit.

81. A wavelength-tunable vertical cavity surface emitting laser circuit comprising:
a monocrystalline substrate;
a portion of an MOS circuit formed in said substrate;
a portion of a vertical cavity surface emitting laser overlying said substrate, wherein said portion of said vertical cavity surface emitting laser is electrically connected to said portion of an MOS circuit and comprises:
an accommodating buffer layer overlying said substrate;
a monocrystalline piezoelectric material layer overlying said accommodating buffer layer;
a template layer overlying said piezoelectric material layer; and
a laser structure overlying said template layer, wherein said laser structure comprises:
a first reflective mirror overlying said template layer, wherein said first reflective mirror comprises a plurality of alternating first monocrystalline material layers and second monocrystalline material layers;
an active layer overlying a final second monocrystalline material layer of said first reflective mirror; and
a second reflective mirror overlying said active layer, wherein said second reflective mirror comprises a plurality of alternating third monocrystalline material layers and fourth monocrystalline material layers.

82. The vertical cavity surface emitting laser circuit of claim 81, wherein said monocrystalline substrate comprises material selected from the group consisting of silicon, germanium, silicon carbide, indium phosphide, silicon germanium, gallium arsenide, and indium arsenide.

83. The vertical cavity surface emitting laser circuit of claim 81, wherein said monocrystalline substrate comprises silicon.

84. The vertical cavity surface emitting laser circuit of claim 81, wherein said accommodating buffer layer comprises a monocrystalline oxide material selected from the group consisting of alkaline-earth metal titanates, alkaline-earth metal zirconates, alkaline-earth metal hafnates, alkaline-earth metal tantalates, alkaline-earth metal ruthenates, alkaline-earth metal niobates, and metal oxides.

85. The vertical cavity surface emitting laser circuit of claim 81, wherein said accommodating buffer layer comprises a monocrystalline material selected from the group consisting of BaTiO₃, SrTiO₃, SrₓBa₁₋ₓTiO₃ (where the value of x ranges from 0 to 1), BaZO₃, and SrZO₃.

86. The vertical cavity surface emitting laser circuit of claim 81, wherein said piezoelectric material layer comprises a monocrystalline oxide material.

87. The vertical cavity surface emitting laser circuit of claim 81, wherein said piezoelectric material layer comprises material selected from the group consisting of lead zirconium titanate and barium titanate.

88. The vertical cavity surface emitting laser circuit of claim 81, wherein said template layer comprises one of a semiconductor material and a compound semiconductor material.

89. The vertical cavity surface emitting laser circuit of claim 81, wherein said template layer comprises material selected from the group consisting of Group III-V compounds, mixed Group III-V compounds, Group II-VI compounds, and mixed Group II-VI compounds.

90. The vertical cavity surface emitting laser circuit of claim 81, wherein each of said first monocrystalline material layers and said second monocrystalline material layers comprises one of a semiconductor material and a compound semiconductor material.

91. The vertical cavity surface emitting laser circuit of claim 81, wherein each of said third monocrystalline material layers and said fourth monocrystalline material layers comprises one of a semiconductor material and a compound semiconductor material.

92. The vertical cavity surface emitting laser circuit of claim 81, wherein each of said first monocrystalline material layers, said second monocrystalline material layers, said third monocrystalline material layers, and said fourth monocrystalline material layers comprises a compound semiconductor material independently selected from the group consisting of GaAs, GaSb, InGaAs, GaAlAs, AlGaSb, InP, InGaAsP, and InAlGaAs.

93. The vertical cavity surface emitting laser circuit of claim 81, wherein said active layer comprises a compound semiconductor material selected from the group consisting of GaAs, InP, AlGaAs, InGaAs, InGaAsP, InAlAsP, and InAlGaAs.

94. The vertical cavity surface emitting laser circuit of claim 81, wherein each of said first monocrystalline material layers is characterized by a first lattice constant and each of said second monocrystalline material layers is characterized by a second lattice constant which is substantially lattice matched to said first lattice constant.

95. The vertical cavity surface emitting laser circuit of claim 81, wherein each of said third monocrystalline material layers is characterized by a third lattice constant and each of said fourth monocrystalline material layers is characterized by a fourth lattice constant which is substantially lattice matched to said third lattice constant.

96. The vertical cavity surface emitting laser circuit of claim 81, further comprising an amorphous intermediate layer overlying said monocrystalline substrate and underlying said accommodating buffer layer.

97. The vertical cavity surface emitting laser circuit of claim 96, wherein said amorphous intermediate layer comprises silicon oxide.

98. A wavelength-tunable vertical cavity surface emitting laser circuit comprising:
a monocrystalline substrate;
a portion of an MOS circuit formed in said substrate;
a portion of a vertical cavity surface emitting laser overlying said substrate, wherein said portion of said vertical cavity surface emitting laser is electrically connected to said portion of an MOS circuit and comprises:
a first accommodating buffer layer overlying said substrate;
a laser structure overlying said first accommodating buffer layer, wherein said laser structure comprises:
a first reflective mirror overlying said first accommodating buffer layer, wherein said first reflective mirror comprises a plurality of alternating first monocrystalline material layers and second monocrystalline material layers;
an active layer overlying a final second monocrystalline material layer of said first reflective mirror; and
a second reflective mirror overlying said active layer, wherein said second reflective mirror comprises a plurality of alternating third monocrystalline material layers and fourth monocrystalline material layers;
a second accommodating buffer layer overlying a final fourth monocrystalline material layer; and
a monocrystalline piezoelectric material layer overlying said second accommodating buffer layer.

99. The vertical cavity surface emitting laser circuit of claim 98, wherein said monocrystalline substrate comprises material selected from the group consisting of silicon, germanium, silicon carbide, indium phosphide, silicon germanium, gallium arsenide, and indium arsenide.

100. The vertical cavity surface emitting laser circuit of claim 98, wherein said monocrystalline substrate comprises silicon.

101. The vertical cavity surface emitting laser circuit of claim 98, wherein each of said first accommodating buffer layer and said second accommodating buffer layer comprises a monocrystalline oxide material independently selected from the group consisting of alkaline-earth metal titanates, alkaline-earth metal zirconates, alkaline-earth metal hafnates, alkaline-earth metal tantalates, alkaline-earth metal ruthenates, alkaline-earth metal niobates, and metal oxides.

102. The vertical cavity surface emitting laser circuit of claim 98, wherein each of said first accommodating buffer layer and said second accommodating buffer layer comprises a monocrystalline material independently selected from the group consisting of BaTiO₃, SrTiO₃, SrₓBa₁₋ₓTiO₃ (where the value of x ranges from 0 to 1), BaZO₃, and SrZO₃.

103. The vertical cavity surface emitting laser circuit of claim 98, wherein said piezoelectric material layer comprises a monocrystalline oxide material.

104. The vertical cavity surface emitting laser circuit of claim 98, wherein said piezoelectric material layer comprises material selected from the group consisting of lead zirconium titanate and barium titanate.

105. The vertical cavity surface emitting laser circuit of claim 98, wherein each of said first monocrystalline material layers and said second monocrystalline material layers comprises one of a semiconductor material and a compound semiconductor material.

106. The vertical cavity surface emitting laser circuit of claim 98, wherein each of said third monocrystalline material layers and said fourth monocrystalline material layers comprises one of a semiconductor material and a compound semiconductor material.

107. The vertical cavity surface emitting laser circuit of claim 98, wherein each of said first monocrystalline material layers, said second monocrystalline material layers, said third monocrystalline material layers, and said fourth monocrystalline material layers comprises a compound semiconductor material independently selected from the group consisting of GaAs, GaSb, InGaAs, GaAlAs, AlGaSb, InP, InGaAsP, and InAlGaAs.

108. The vertical cavity surface emitting laser circuit of claim 98, wherein said active layer comprises a compound semiconductor material selected from the group consisting of GaAs, InP, AlGaAs, InGaAs, InGaAsP, InAlAsP, and InAlGaAs.

109. The vertical cavity surface emitting laser circuit of claim 98, wherein each of said first monocrystalline material layers is characterized by a first lattice constant and each of said second monocrystalline material layers is characterized by a second lattice constant which is substantially lattice matched to said first lattice constant.

110. The vertical cavity surface emitting laser circuit of claim 98, wherein each of said third monocrystalline material layers is characterized by a third lattice constant and each of said fourth monocrystalline material layers is characterized by a fourth lattice constant which is substantially lattice matched to said third lattice constant.

111. The vertical cavity surface emitting laser circuit of claim 98, further comprising a first amorphous intermediate layer overlying said monocrystalline substrate and underlying said first accommodating buffer layer.

112. The vertical cavity surface emitting laser circuit of claim 111, wherein said first amorphous intermediate layer comprises silicon oxide.

113. The vertical cavity surface emitting laser circuit of claim 111, further comprising a second amorphous intermediate layer overlying said final fourth monocrystalline material layer and underlying said second accommodating buffer layer.

114. The vertical cavity surface emitting laser circuit of claim 98, further comprising a template layer overlying said first accommodating buffer layer and underlying an initial first monocrystalline material layer of said first reflective mirror.

115. The vertical cavity surface emitting laser circuit of claim 114, wherein said template layer comprises one of a semiconductor material and a compound semiconductor material.

116. The vertical cavity surface emitting laser circuit of claim 114, wherein said template layer comprises a material selected from the group consisting of Group III-V compounds, mixed Group III-V compounds, Group II-VI compounds, and mixed Group II-VI compounds.

117. A wavelength-tunable optical device structure comprising:
a monocrystalline substrate;
a monolithically-integrated optical device positioned above said substrate;
a monocrystalline piezoelectric material layer monolithically integrated with said optical device, wherein said piezoelectric material layer is positioned either above or below an active layer of said optical device.

118. A wavelength-tunable vertical cavity surface emitting laser comprising:
a monocrystalline substrate;
a laser structure positioned above said substrate, wherein said laser structure comprises:
a first reflective mirror comprising a plurality of alternating first monocrystalline material layers and second monocrystalline material layers;
a monocrystalline active layer overlying a final second monocrystalline material layer of said first reflective mirror; and
a second reflective mirror overlying said active layer, wherein said second reflective mirror comprises a plurality of alternating third monocrystalline material layers and fourth monocrystalline material layers; and
a monocrystalline piezoelectric material layer monolithically integrated with said laser structure, wherein said piezoelectric material layer is positioned either above or below said active layer.

119. A process for fabricating a wavelength-tunable optical device structure, the process comprising the steps of:
providing a monocrystalline substrate;
epitaxially growing an accommodating buffer layer over at least one of said substrate, an amorphous intermediate layer, and an optical device;
epitaxially growing a piezoelectric material layer over said accommodating buffer layer;
epitaxially growing a template layer over at least one of said piezoelectric material layer and said accommodating buffer layer;
epitaxially growing alternating first monocrystalline material layers and second monocrystalline material layers, wherein each of said first monocrystalline material layers and said second monocrystalline material layers comprises one of a semiconductor material and a compound semiconductor material; and
epitaxially growing an active layer over a final second monocrystalline material layer.

120. The process of claim 119, further comprising epitaxially growing alternating third monocrystalline material layers and fourth monocrystalline material layers, wherein each of said third monocrystalline material layers and said fourth monocrystalline material layers comprises one of a semiconductor material and a compound semiconductor material.

121. The process of claim 120, wherein growing alternating third monocrystalline material layers and fourth monocrystalline material layers comprises epitaxially growing alternating layers of compound semiconductor materials independently selected from the group consisting of GaAs, GaSb, InGaAs, GaAlAs, AlGaSb, InP, InGaAsP, and InAlGaAs.

122. The process of claim 119, wherein growing an accommodating buffer layer comprises epitaxially growing an oxide material selected from the group consisting of alkaline-earth metal titanates, alkaline-earth metal zirconates, alkaline-earth metal hafnates, alkaline-earth metal tantalates, alkaline-earth metal ruthenates, alkaline-earth metal niobates, and metal oxides.

123. The process of claim 119, wherein growing an accommodating buffer layer comprises epitaxially growing a layer of material selected from the group consisting of BaTiO₃, SrTiO₃, SrₓBa₁₋ₓTiO₃ (where the value of x ranges from 0 to 1), BaZO₃, and SrZO₃.

124. The process of claim 119, wherein growing a piezoelectric material layer comprises epitaxially growing an oxide material layer.

125. The process of claim 124, wherein growing a piezoelectric material layer comprises epitaxially growing a piezoelectric material layer over said accommodating buffer layer and adjacent to said optical device.

126. The process of claim 119, wherein growing a piezoelectric material layer comprises epitaxially growing a layer of material selected from the group consisting of zirconium titanate and barium titanate.

127. The process of claim 119, wherein growing a template layer comprises epitaxially growing a layer of one of a semiconductor material and a compound semiconductor material.

128. The process of claim 119, wherein growing alternating first monocrystalline material layers and second monocrystalline material layers comprises epitaxially growing alternating layers of compound semiconductor materials independently selected from the group consisting of GaAs, GaSb, InGaAs, GaAlAs, AlGaSb, InP, InGaAsP, and InAlGaAs.

129. The process of claim 119, wherein growing an active layer comprises epitaxially growing a layer of material selected from the group consisting of GaAs, InP, AlGaAs, InGaAs, InGaAsP, InAlAsP, and InAlGaAs.

130. The process of claim 119, further comprising oxidizing an underlying material during growth of an overlying material layer to form an amorphous intermediate layer at an interface between said underlying material and said overlying material layer.

131. The process of claim 119, further comprising substantially matching a first lattice constant of a growing material layer with a second lattice constant of an underlying host material layer.

132. The process of claim 119, wherein growing an accommodating buffer layer comprises epitaxially growing an accommodating buffer layer over at least one of said substrate, an amorphous intermediate layer, and a laser structure.

133. The process of claim 119, wherein growing an accommodating buffer layer comprises epitaxially growing an accommodating buffer layer over at least one of said substrate, an amorphous intermediate layer, and a photodetector structure.
